(19) United States
(12) Patent Application Publication
(10) Pub. No.: US 2018/0203961 A1
(43) Pub. Date: Jul. 19, 2018

(54) OPERATION DRAFT PLAN CREATION APPARATUS, OPERATION DRAFT PLAN CREATION METHOD, NON-TRANSITORY COMPUTER READABLE MEDIUM, AND OPERATION DRAFT PLAN CREATION SYSTEM

(71) Applicant: Kabushiki Kaisha Toshiba, Tokyo (JP)

(72) Inventors: Hideyuki Aisu, Kawasaki Kanagawa (JP); Mikito Iwamasa, Shinagawa Tokyo (JP); Gaku Ishii, Kawasaki Kanagawa (JP); Shinichi Nagano, Yokohama Kanagawa (JP); Tomoshi Otsuki, Kawasaki Kanagawa (JP)

(73) Assignee: Kabushiki Kaisha Toshiba, Tokyo (JP)

(21) Appl. No.: 15/919,609

(22) Filed: Mar. 13, 2018

Related U.S. Application Data
(63) Continuation of application No. PCT/JP2016/087781, filed on Dec. 19, 2016.

(30) Foreign Application Priority Data
Mar. 16, 2016 (JP) 2016-052929

(51) Int. Cl. G06F 17/50; G06F 17/18; G06T 11/20

(52) U.S. Cl. CPC G06F 17/5009; G06T 11/206; G06F 17/18

(57) ABSTRACT

An operation-draft-plan creation apparatus according to an embodiment of the present invention includes an acquirer, a simulator, and an operation-draft-plan creator. The acquirer acquires a deterioration model regarding performance of a similar measurement target. The similar measurement target is a measurement target considered to be similar to an operation target. The deterioration model is calculated on the basis of a measurement value of the similar measurement target. The simulator performs a simulation concerning deterioration of the performance of the operation target on the basis of the deterioration model regarding the performance of the similar measurement target and a use case example assumed for the operation target. The creator creates an operation draft plan on the basis of a result of the simulation. The operation draft plan indicates an implementation period of maintenance work performed on the operation target.

### CROSS-REFERENCE TO RELATED APPLICATION (S)

This application is a Continuation of International Application No. PCT/JP2016/087781, filed on Dec. 19, 2016, the entire contents of which is hereby incorporated by reference.

### FIELD

Embodiments described herein relate generally to an operation draft plan creation apparatus, an operation draft plan creation method, a non-transitory computer readable medium, and an operation draft plan creation system.

### BACKGROUND

In recent years, constant monitoring by a sensor or the like is performed on equipment or an apparatus, performance of which is deteriorated according to the elapse of years, for the purpose of early finding of abnormality. Consequently, it is possible to quickly find abnormality compared with the conventional maintenance performed on-site and perform maintenance work before the equipment or the like breaks down.

However, when the maintenance work is performed every time abnormality is detected, sudden cost is incurred. After replacement of a component of the apparatus is performed, a situation often occurs in which another component becomes abnormal and the entire apparatus is replaced. To avoid such a situation, it is necessary to draw up a long-term operation plan in anticipation of a life cycle of the equipment, the apparatus, or the entire building.

In general, an operation plan is created according to durable years of the equipment or the like, an update period of a lease agreement, or the like. An appropriate operation plan cannot be created unless a progress of deterioration of the equipment or the like is highly accurately grasped. However, the progress of the deterioration of the equipment or the like is different depending on a use situation, an environment of a setting place, or the like. In some case, it is desired to create an operation draft plan of other equipment or the like scheduled to be set in future. Further, in some case, deterioration of performance cannot be directly calculated from measurement items.

### BRIEF DESCRIPTION OF THE DRAWINGS

FIG. 1 is a block diagram showing an example of a schematic configuration of an operation-draft-plan creation apparatus according to a first embodiment.

FIG. 2 is a diagram showing an example of a deterioration model generated by a deterioration-model generator.

FIG. 3 is a flowchart of deterioration-model generation processing.

FIG. 4 is a block diagram showing an example of a schematic configuration of the deterioration-model generator in the case in which a particle filter is used as an estimation method.

FIGS. 5A to 5E are diagrams showing contents of processing of the particle filter.

FIG. 6 is a flowchart of estimation processing of internal parameters by the particle filter.

FIG. 7 is a flowchart of building-model extraction processing.

FIGS. 8A and 8B are diagrams showing examples of operation draft plans.

FIGS. 9A and 9B are diagrams showing other examples of the operation draft plans.

FIG. 10 is a flowchart of operation-draft-plan creation processing.

FIG. 11 is a block diagram showing an example of a schematic configuration of an operation-draft-plan creation apparatus according to a second embodiment.

FIGS. 12A to 12D are diagrams showing examples of element simplification.

FIGS. 13A to 13D are diagrams showing examples of linearization.

FIGS. 14A to 14C are diagrams for explaining division.

FIGS. 15A to 15D are diagrams for explaining reconfiguration of divided pieces.

FIGS. 16A and 16B are diagrams for explaining aggregation.

FIG. 17 is a flowchart of spatial-shape machining processing.

FIG. 18 is a block diagram showing an example of a schematic configuration of a spatial-shape editor.

FIG. 19 is a diagram showing an example of a method of acquiring direction axes.

FIG. 20 is a flowchart for generating division lines.

FIG. 21 is a diagram for explaining processing for simplification section setting.

FIG. 22 is a flowchart for calculating a simplified area threshold.

FIG. 23 is a flowchart of element simplification processing.

FIGS. 24A to 24D are diagrams for explaining simplification of a concave section in element simplification.

FIG. 25 is a flowchart of machining processing for an outer periphery.

FIG. 26 is a flowchart of machining processing for an inside.

FIG. 27 is a flowchart of linearization processing.

FIGS. 28A to 28E are diagrams for explaining simplification of a convex section in linearization.

FIGS. 29A to 29E are diagrams for explaining simplification of a concave section in the linearization.

FIGS. 30A to 30E are diagrams for explaining simplification of a concave edge.

FIGS. 31A to 31D are diagrams for explaining both-edge simplification.

FIG. 32 is a flowchart of simplification of an edge section.

FIG. 33 is a flowchart of the simplification of the concave edge.

FIGS. 34A and 34B are diagrams for explaining shaping of the edge section.

FIG. 35 is a block diagram showing an example of a schematic configuration of a spatial-structure editor.

FIG. 36 is a schematic flowchart of spatial-structure machining processing.

FIG. 37 is a block diagram showing an example of a hardware configuration that realizes a spatial-information generation apparatus according to the embodiment.

### DETAILED DESCRIPTION

An operation-draft-plan creation apparatus according to an embodiment of the present invention creates an operation draft plan for equipment or an apparatus, the performance of which is deteriorated according to the elapse of years.

An operation-draft-plan creation apparatus according to an embodiment of the present invention includes an acquirer, a simulator, and an operation-draft-plan creator. The acquirer acquires a deterioration model regarding performance of a similar measurement target. The similar measurement target is a measurement target considered to be similar to an operation target. The deterioration model is calculated on the basis of a measurement value of the similar measurement target. The simulator performs a simulation concerning deterioration of the performance of the operation target on the basis of the deterioration model regarding the performance of the similar measurement target and a use case example assumed for the operation target. The operation-draft-plan creator creates an operation draft plan indicating an implementation period of maintenance work performed on the operation target on the basis of a result of the simulation.

Below, a description is given of embodiments of the present invention with reference to the drawings. The present invention is not limited to the embodiments.

### First Embodiment

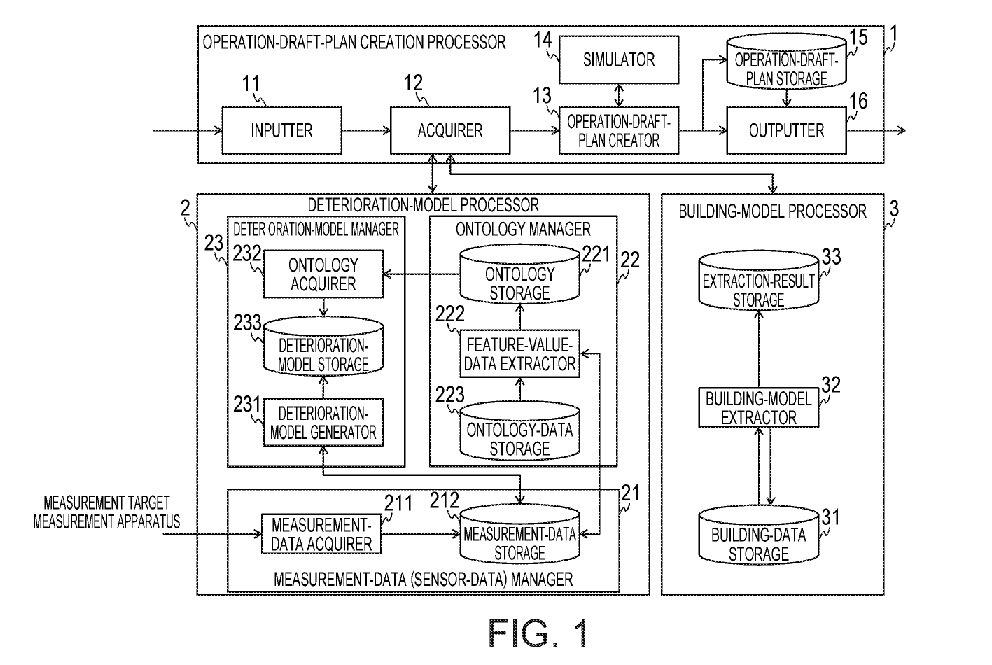

FIG. 1 is a block diagram showing an example of a schematic configuration of an operation-draft-plan creation apparatus according to a first embodiment. The operation-draft-plan creation apparatus according to the first embodiment includes an operation-draft-plan creation processor 1, a deterioration-model processor 2, and a building-model processor 3.

The operation-draft-plan creation processor 1 includes an inputter 11, an acquirer 12, an operation-draft-plan creator 13, a simulator 14, an operation-draft-plan storage 15, and an outputter 16.

The deterioration-model processor 2 includes a measurement-data (sensor-data) manager 21, an ontology manager 22, and a deterioration-model manager 23. The measurement-data manager 21 includes a measurement-data acquirer 211 and a measurement-data storage 212. The ontology manager 22 includes an ontology storage 221, a feature-value-data extractor (use-case-example extractor) 222, and an ontology-data storage 223. The deterioration-model manager 23 includes a deterioration-model generator (a parameter calibrator) 231, an ontology acquirer 232, and a deterioration-model storage 233.

The building-model processor 3 includes a building-data storage 31, a building-model extractor 32, and an extraction-result storage 33.

The operation-draft-plan creation apparatus according to the first embodiment creates an operation draft plan of an operation target. The operation target is equipment, an apparatus (equipment, etc.), or the like. The operation target only has to be an object, the performance of which is deteriorated by aged deterioration. For example, an air conditioning apparatus and a power supply apparatus can be the operation target. It is assumed that the deterioration of the operation target depends on a way of use of the operation target, an environment of a setting place, and the like.

Incidentally, a factor causing the deterioration of the operation target such as the way of use of the operation target or the environment of the setting place is referred to as use example case.

The operation draft plan indicates an implementation period of maintenance work performed on the operation target.

The maintenance work includes work such as replacement, inspection, cleaning, and repairing of a part of or the entire equipment or the like and replacement with an apparatus of a new type. Incidentally, the operation draft plan is not only created for each kind of equipment or the like. The operation draft plan of an entire building in which a plurality of kinds of equipment and the like are set may be created.

The implementation period of the maintenance work of the operation draft plan may be determined on the basis of a factor other than the deterioration of the performance of the operation target. For example, the implementation period of the maintenance work of the operation draft plan may be determined on the basis of cost and the like for the operation target.

The operation draft plan is created on the basis of a use case example of the operation target and a deterioration model of the operation target. The deterioration model indicates a transition of deterioration of performance in the operation target or the like. Specifically, the deterioration model is transition data of predetermined parameters concerning the performance.

Further, the operation draft plan may be created on the basis of a building model of the operation target. The building model is used as a model of a setting place of the operation target. When the operation target is air conditioning equipment or the like, a space in which the air conditioning equipment performs air conditioning may be a building model. This is because the transition of the deterioration of the performance is different depending on a difference of the building model.

The building model indicates the shape and the structure of a building or a component of the building. The component of the building is not particularly limited as long as the component is present in the building. For example, the components may be a room, a corridor, a wall, a staircase, equipment, or an apparatus. It is assumed that the building model of the operation target is a building model of a building in which the operation target is set or a building in which the operation target is scheduled to be set. However, it is assumed that the operation draft plan in this embodiment is created reusing a deterioration model and a building model based on another target similar to the operation target rather than the deterioration model and the building model based on the operation target.

It is assumed that the other target is a measurement target of a measurement apparatus (a sensor) or the like. The deterioration-model processor 2 generates a deterioration model of the measurement target on the basis of measurement data by the measurement apparatus. The other target which can be regard as being similar to the operation target satisfies both (1) equipment or the like of the same type as the operation target and (2) an attribute or the like of which coincides with an attribute or the like of the operation target or a value of the attribute of which is equal to or smaller than a predetermined threshold. Even if the attributes do not coincide, when a relation of both the attributes is registered in predetermined similarity relation data indicating a similarity relation, both the attributes may be regarded as similar. The attribute of the operation target is not particularly limited. For example, the attribute may be a use, a purpose, a using method, a using time, a setting building, or a setting place of the operation target.

By using the deterioration model based on the other target similar to the operation target, it is also possible to create an operation draft plan of equipment or the like of a building in which a sensor or the like is not disposed or equipment or the like scheduled to be set in a building to be constructed in future.

Incidentally, as the use case example and the building model of the operation target, a use case example and a building model of another target similar to the operation target may be used.

Incidentally, in this embodiment, the operation-draft-plan creation apparatus includes the operation-draft-plan creation processor 1, the deterioration-model processor 2, and the building-model processor 3. However, these respective devices may be created as separate devices and may be constructed as a system that performs exchange of data. The exchange of the data may be performed by wired or wireless communication or may be performed by electronic signals. The deterioration-model processor 2 and the building-model processor 3 may be present on a network. As a cloud service or the like, the deterioration model and the building model may be transmitted to the operation-draft-plan creation processor 1.

Internal components of the operation-draft-plan creation processor 1, the deterioration-model processor 2, and the building-model processor 3 may be created as separate devices. For example, the measurement-data manager 21 may be present as an independent device. The measurement-data manager 21 may acquire measurement data by wired or wireless communication and transmit the measurement data to the deterioration-model management apparatus and the ontology management apparatus.

First, the deterioration-model processor 2 is explained. The measurement-data manager 21 of the deterioration-model processor 2 collects and manages measurement data obtained by measuring a measurement target such as equipment. It is assumed that the measurement target includes equipment or the like of the same type as the operation target. For example, when the operation target is an air conditioning apparatus, it is assumed that the air conditioning apparatus is included as the measurement target. Attributes of the operation target such as a manufacturer, a model number, and a setting value may be the same or may be different as long as the operation target and the measurement target are the same type.

The measurement-data acquirer 211 of the measurement-data manager 21 collects measurement data by communication, an electric signal, or the like from the measurement target itself, a measurement apparatus (a sensor) that monitors the measurement target, or a measurement system that administers the measurement apparatus. In this embodiment, the measurement target, the measurement apparatus, and the measurement system are not particularly limited.

The measurement data may be any data as long as the measurement target or the measurement apparatus can measure the data. For example, the measurement data may be a setting value, power consumption, a control signal, or a log of an error or the like. For example, when the measurement apparatus is air conditioning equipment, the measurement data may be temperature and humidity of a room, a flow rate and temperature of water flowing into and out of a heat exchanger, or operation sound of an apparatus. The measurement data may include one kind or a plurality of kinds of items.

The measurement-data acquirer 211 may poll and acquire the measurement data at any timing. Alternatively, the operation target, the measurement apparatus, or the measurement system may transmit the measurement data to the measurement-data acquirer 211 at any timing. The collected measurement data is sent to the measurement-data storage 212 and stored in the measurement-data storage 212.

The ontology manager 22 of the deterioration-model processor 2 manages ontology. The ontology is systemization of a relation between concepts, a relation between a concept and a specific example, or the like. As models of the ontology, there is, for example, a RDF (Resource Description Framework) explained below. However, the ontology is not particularly limited in this embodiment.

For example, in the model of the RDF, a resource is expressed using three elements, that is, a subject, a predicate, and an object. The subject is a resource itself which is attempting to express. The predicate indicates a characteristic of the subject or a relation between the subject and the object. The object indicates a thing related to the subject or a value of the predicate. A relation among the three elements is referred to as relation information (triple). In general, a set of triples is called RDF graph. In the RDF graph, the subject and the object are represented as nodes, the predicate is represented as a link, and the entire subject, object, and predicate are represented as one knowledge graph. In the knowledge graph, the ontology represents a relation between concepts.

The ontology storage 221 (a knowledge-graph storage) of the ontology manager 22 stores ontology related to the measurement target. The deterioration-model manager 23 uses the ontology when searching for a similar case example. The ontology stored in the ontology storage 221 is stored as a knowledge graph like the RDF graph in which measurement data, measurement target data (specification data), space data, feature value data, and incident data are associated with one another. The space data is data concerning a space in which the measurement target is set. For example, the space data may be data indicating a type of a building in which the measurement target is set such as an individual home, a commercial building, or a factory. The space data may be data indicating a setting place such as a floor number, a room number, and a position in a room in which the measurement target is set.

The measurement target data (the specification data) is data concerning the measurement target. For example, the measurement target data may be data indicating a type: a use, a role, a manufacturer name, initial performance, a use condition, an assumed number of durable years, and the like of equipment. The measurement target data also includes electronic records of incidents such as content of maintenance work performed on the measurement target, a report of abnormality or a record of a failure that occurs in the measurement target, and an event affecting the measurement target such as a layout change of a setting plate of the equipment or replacement of a tenant.

The feature value data is data indicating a feature value of the measurement data. The feature value may be, for example, an average, a maximum, a minimum, or the like of values of the measurement data. Alternatively, for example, the feature value data may be a characteristic state, event, or the like in which the measurement target is always in a specific state in a predetermined period or setting is always changed at predetermined time. The feature value data may be data indicating, for example, content of a feature value, duration of the feature value, an extraction method for the feature value, information necessary for the extraction method, and a value representing the feature value. The feature value data may be used as a use case example of the measurement target.

The incident data is data concerning a specific event (incident) included in the measurement data. The incident data may be, for example, content of maintenance work performed on the measurement target. The incident data may be content of an abnormality or a failure that occurs in the measurement target. Alternatively, the incident data may be a reporter who confirms the abnormality of the like. The incident data may be an event affecting the measurement target such as a layout change of a setting place of the equipment, replacement of a tenant, or the like. The incident data also may be used as use case examples of the measurement target.

The feature-value-data extractor 222 of the ontology manager 22 performs extraction of the feature value data or the incident data on the basis of the measurement data of the measurement-data storage 212. It is assumed that information for performing the extraction, for example, a measurement target, a target period (measurement date and time), an extraction method for a feature value, and information necessary for the extraction method are given in advance.

As a method of extracting the feature value data and the like, for example, there is a method of extracting the feature value data and the like on the basis of a statistical amount such as an average of measurement data in a target period or comparison with a threshold. In the case of the threshold, the number of measurement data larger than the threshold or the number of measurement data smaller than the threshold is totalized as a feature value (a frequency). An approximation representing method for time-series data called SAX method may be adopted to convert measurement data into a character string expression. The SAX method divides the target period by a designated number of segments, calculates an average of data in the respective segments, thereafter, divides respective areas of a normal distribution by a designated number of alphabets to be equal, and allocates character strings (alphabets) to the respective divided segments. It is assumed that the number of segments and the like for using the SAX method are also given.

The feature-value-data extractor 222 updates the ontology (the knowledge graph) stored in the ontology storage 221 with the extracted feature value data or the like.

According to the ontology, it is possible to detect respective data with abstract search keywords concerning a type, a use environment, a setting place, specifications of a building, and the like of the measurement target. For example, even with a search keyword “it is very hot in the setting place in summer”, it is possible to search for other data concerning the ontology on the basis of measurement data. Even with a search keyword “the setting place is the top floor on the west side”, it is possible to search for other data concerning the ontology on the basis of space data.

Incidentally, the feature-value-data extractor 222 may function as an ontology (knowledge-graph) generator and generate ontology. The feature-value-data extractor 222 only has to generate ontology on the basis of a conversion format in which it is decided where space data, measurement target data, measurement data, characteristic data, and incident data are arranged. When the feature-value-data extractor 222 functions as the ontology (knowledge-graph) generator and generates ontology, it is assumed that the ontology-data storage 223 stores the conversion format, the space data, and the measurement target data in advance. The feature-value-data extractor 222 may acquire the conversion format, the space data, and the measurement target data from the ontology-data storage 223, acquire the measurement data from the measurement-data storage 212, and calculate the feature value data and the incident data from the measurement data and then generate ontology (a knowledge graph) from the beginning.

The deterioration-model manager 23 of the deterioration-model processor 2 manages the deterioration model. The deterioration model in this embodiment is transition data indicating a transition of parameters indicating the performance of the measurement target. The deterioration model is associated with the ontology of the measurement target. Consequently, it is possible to search for a deterioration model of a measurement target, a use case example or the like of which is similar to the operation target, using the feature value data, the abstract search keywords, or the like.

The deterioration-model generator (the parameter calibrator) 231 of the deterioration-model manager 23 generates a deterioration model on the basis of the measurement data stored in the measurement-data storage 212.

The deterioration-model generator 231 calculates a value of a predetermined parameter of the measurement target at certain time on the basis of measurement data in the predetermined period. The calculation of the value of the parameter is cyclically performed. In this way, the deterioration-model generator 231 generates a deterioration model, which is data indicating a transition of the parameter, on the basis of values of the parameter at a plurality of times.

Incidentally, for a parameter that cannot be directly calculated from a measurement item included in the measurement data, the deterioration-model generator 231 may generate a deterioration model by estimating a value of the parameter. For example, when the measurement target is air conditioning equipment, a setting temperature of air conditioning, temperature of a room, and the like can be measured by a measurement apparatus or the like. However, coefficient of performance (COP) of the air conditioning equipment cannot be measured and is not included in the measurement data. Such internal parameters (non-measurement parameters) that cannot be directly measured are estimated by a simulation or the like based on the measurement data. A deterioration model of the internal parameter is generated on the basis of estimated values or probability density distributions at a plurality of times. Incidentally, parameters may be estimated as internal parameters, the parameters being measurable but not actually measured and not included in the measurement data.

The estimation method is not particularly limited. For example, a well-known sequential optimization method such as a simulated annealing (SA) method or a well-known probability distribution estimation method such as a particle filter may be used. An existing simulator such as the simulator 14 may be used. The calculated estimated value of the parameter may be uniquely decided or may be represented by a probability density distribution.

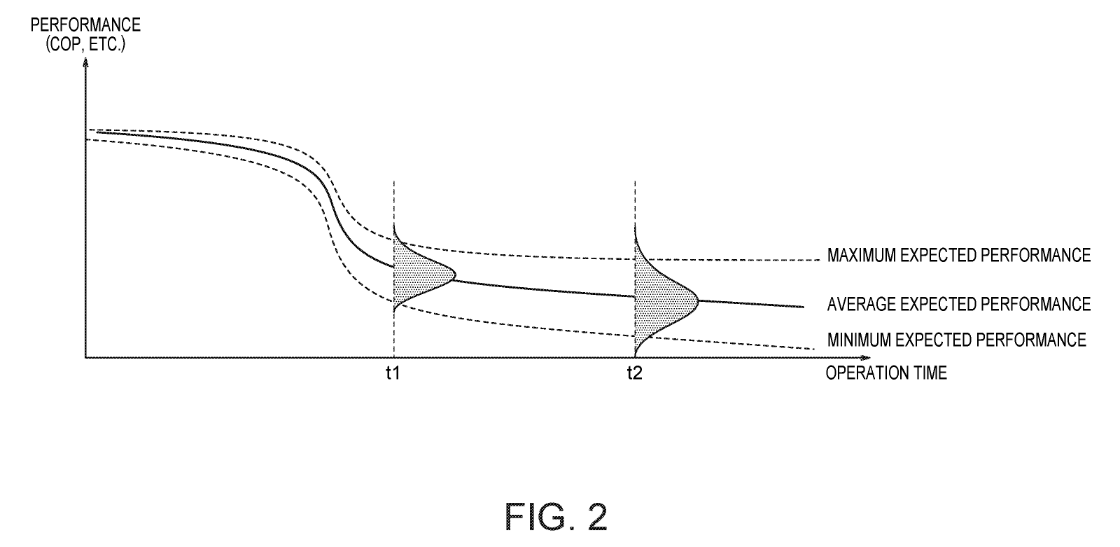

FIG. 2 is a diagram showing an example of a deterioration model representing, with the probability density distribution, the estimated value of the parameter generated by the deterioration-model generator 231. The horizontal axis indicates an operation time of the measurement target. The vertical axis indicates a value of a parameter of the measurement target. The deterioration model is represented by a time-series transition of an internal parameter as shown in FIG. 2. Three graphs are shown in FIG. 2. A top graph of a dotted line (maximum expected performance) indicates estimated maximum performance. A bottom graph of a dotted line (minimum expected performance) indicates estimated minimum performance. A graph of a solid line (average expected performance) presents between the maximum expected performance and the minimum expected performance, and the graph indicates estimated average performance.

In FIG. 2, at times t1 and t2, normal distributions are shown on the three graphs. The normal distributions are probability density distributions of the parameter calculated by the deterioration-model generator 231 at the times t1 and t2. Variation of the probability density distribution at the time t2 is larger than variation of the probability density distribution at the time t1. In this way, in general, an estimated probability density distribution often increases according to the elapse of time.

The deterioration-model generator 231 calculates the probability density distributions of the parameter at the respective times and joins the calculated probability density distributions to thereby generate transition data. The transition data generated by the deterioration-model generator 231 is stored in the deterioration-model storage 233.

The ontology acquirer 232 of the deterioration-model manager 23 acquires the ontology from the ontology storage 221 and causes the deterioration-model storage 233 to store the ontology. Incidentally, the ontology acquirer 232 may acquire, rather than the ontology, position information (a link) indicating the position of the ontology stored in the ontology storage 221.

The deterioration-model storage 233 may store, for each of measurement targets, the transition data sent from the deterioration-model generator 231 and the ontology including the feature value data sent from the ontology acquirer 232 in association with each other as indexes for search. Incidentally, the deterioration-model storage 233 may store, instead of the ontology, the position information (the link) indicating the position of the ontology stored in the ontology storage 221 in association with the transition data.

The deterioration-model storage 233 receives a search condition from the acquirer 12 and extracts a deterioration model matching the search condition. The ontology is used as an index in extracting transition data. Consequently, it is possible to search for a deterioration model of the measurement target similar to the operation target using search keywords related to the space data, the measurement target data, the measurement data, the feature value data, and the incident data included in the ontology.

For example, when the acquirer 12 of the operation-draft-plan creation processor 1 receives a use case example assumed for the operation target via the inputter 11, the use case example may be passed to the deterioration-model storage 233. The deterioration-model storage 233 may pass a deterioration model of a measurement target having a use case example similar to the use case example to the acquirer 12. The deterioration-model storage 233 may receive a use condition or the like of information or a building of an operation target, detect a measurement target similar to the operation target or a measurement target matching the use condition or the like, and pass a use case example and a deterioration model of the measurement target to the acquirer 12.

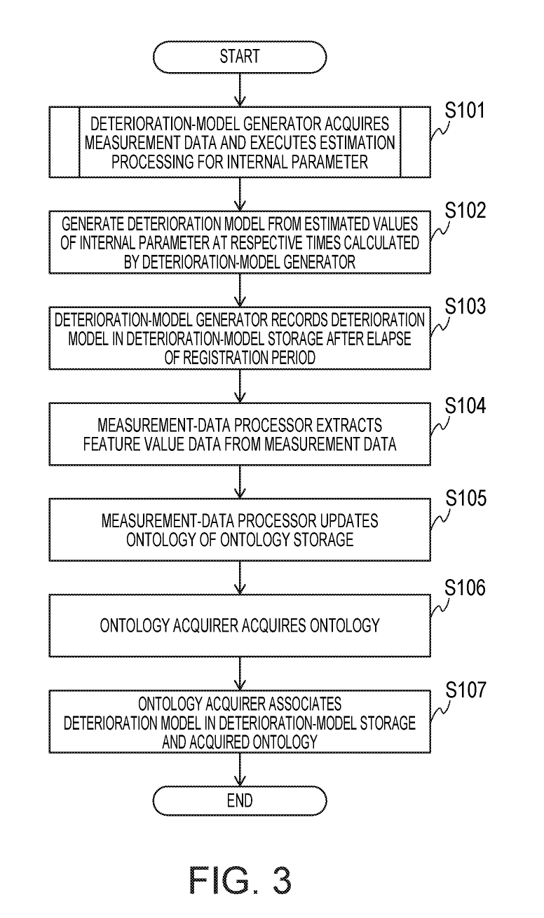

FIG. 3 is a flowchart of deterioration-model generation processing. It is assumed that measurement data is already stored in the measurement-data storage 212.

The deterioration-model generator 231 acquires the measurement data from the measurement-data storage 212 and executes estimation processing for an internal parameter (S101). A flow of the estimation processing for an internal parameter is explained below.

The deterioration-model generator 231 generates a deterioration model, which is transition data, from calculated estimated values of the internal parameter at the respective times (S102). The deterioration model may be updated by adding an estimated value of the internal parameter estimated anew to an estimated value of the same target already created in the past. The deterioration-model generator 231 records the deterioration model in the deterioration-model storage 233 after the elapse of a registration period (S103).

On the other hand, the feature-value-data extractor 222 acquires measurement data from the measurement-data storage 212 and extracts feature value data from the measurement data (S104). The feature-value-data extractor 222 updates the ontology of the ontology storage 221 with the extracted feature value data (S105).

The ontology acquirer 232 acquires the ontology or position information from the ontology storage 221 periodically or when the ontology is updated (S106). The ontology acquirer 232 associates, for each operation, the deterioration model in the deterioration-model storage 233 and the acquired ontology (S107). The flow of the deterioration-model generation processing according to the first embodiment is as explained above.

Incidentally, this flowchart is an example and is not limited to this example. For example, no problem occurs even if the processing in S104 and S105 is performed before S101. If no problem occurs in this way, the order and the like of the processing may be interchanged. The same applies to flowcharts explained below.

The estimation of an internal parameter performed by the deterioration-model generator 231 is explained now. As an estimation method for an internal parameter, Bayesian estimation or the like is used. When a measured state based on measurement data is represented as Y and an unmeasured state (an estimated state or a non-measured state) is represented as X, estimating the state X on the basis of the state Y is the same as calculating a probability (a posteriori probability) P (X|Y) that the state X occurs when the state Y occurs. The posteriori probability P (X|Y) is represented by the following equation according to the Baye's theorem.

$$P ( X \vert Y ) = \frac{P ( Y \vert X ) P ( X )}{P ( Y )} \qquad [ Expression 1 ]$$

In the Bayesian estimation, in the above equation, X is set as a probability variable. X is regarded as a parameter in a probability density function P. In the following explanation, X is referred to as estimation parameter. Then, P(X) is a priori probability density distribution of the estimation parameter X. P (X|Y) is a posteriori probability density distribution of the estimation parameter X at the time when the state Y is measured. P(Y) is a priori probability that the state Y occurs. P(X|Y) is a posteriori probability that Y is obtained at the time of the parameter X. P(X|Y) is called likelihood.

Further, the estimation parameter at time t (t is a positive real number) can be replaced with Xt. Expression 1 can be replaced with the following equation.

$$P ( Xt \vert Y 1 : t ) = \frac{P ( Yt \vert Xt ) P ( Xt \vert Y 1 : t - 1 )}{P ( Yt \vert Y 1 : t - 1 )} \qquad [ Expression 2 ]$$

Y1:t means a set of data Y={Y1, Y2, Yt} measured before the time t. That is, P(Xt|Y1:t) means a probability density distribution of the estimation parameter X based on measurement values from measurement start time until the present time.

Incidentally, when focusing on a distribution shape of the probability density distribution, since P(Yt|Y1:t−1) is a constant not depending on X, P(Yt|Y1:t−1) may be neglected. Therefore, P(Xt|Y1:t) is represented by the following equation.

P(Xt|Y1:t)∝P(Yt|Xt)P(Xt|Y1:t−1) [Expression 3]

The above Expression 3 means that, by obtaining the measured value Yt anew and calculating the likelihood P(Yt|Xt), it is possible to sequentially update the posteriori probability density distribution P(Xt|Y1:t−1) estimated from measurement data before prior time t−1 to the posteriori probability density distribution P(Xt|Y1:t) estimated from measurement data before the present time. Therefore, by repeating the calculation of a likelihood and the update of a posteriori probability density distribution starting from an appropriate initial probability density distribution P(X0) at initial time t=0, it is possible to calculate a probability density distribution of the estimation parameter X at the present time.

As a method of calculating a posteriori probability density distribution in this way, Markov chain Monte Carlo methods (MCMC) including a Gibbs method and a metropolis method, a particle method (a particle filter), which is a type of a sequential Monte Carlo method, or the like may be used.

The deterioration-model generator 231 calculates a posteriori probability density distribution using the method decided in advance. Incidentally, the likelihood P(Yt|Xt) can be calculated by a simulation. When the simulation is used, the simulator 14 of the operation-draft-plan creation processor 1 is used. However, the deterioration-model generator 231 itself could sometimes include a simulator.

As an example in which the deterioration-model generator 231 estimates a posteriori probability density distribution, the particle filter used as the estimation method is explained below.

The particle filter is a method of approximating the posteriori probability density distribution P(X|Y) of the estimation parameter X with a distribution of a particle group including a large number of particles. The particle filter sequentially repeats prediction, likelihood calculation, and re-sampling (update of the distribution of the particle group) to thereby calculate a posteriori probability density distribution of the estimation parameter X at the present time.

It is assumed that, in general, the number of particles is optionally decided in a range of one hundred to ten thousand. As a total number of the particles increases, estimation accuracy is improved. However, a time period required for estimation calculation increases. Incidentally, when the number of particles is represented as n (n is a positive integer), the particle group is represented by P={p1, p2, pi, pn}, where i is an integer equal to or larger than 1 and equal to or smaller than n.

Incidentally, when there are a plurality of states to be estimated, the estimation parameter X can be represented by an n-dimensional vector X={x1, x2, xm} including m (m is a positive integer) components. For example, when it is desired to estimate two components, that is, a COP and an assumed heat value per one person, x1 is set as the COP and x2 is set as the assumed heat value per one person. However, the components sometimes include other information. The respective particles include all kinds of information capable of calculating, with the measured value Yt and the components of the particles as inputs, predicted values of the components of the particles and a measured predicted value Yt+1 at time t+1 using a random number and a model formula (a state equation) decided in advance. In this case, an i-th particle is represented by the following equation: pᵢ={x1ᵢ, x2ᵢ, xmᵢ, weight i}, where the weight i is a numerical value used in processing of re-sampling explained below. Values and weights of respective elements of the particle are represented by floating points or integers.

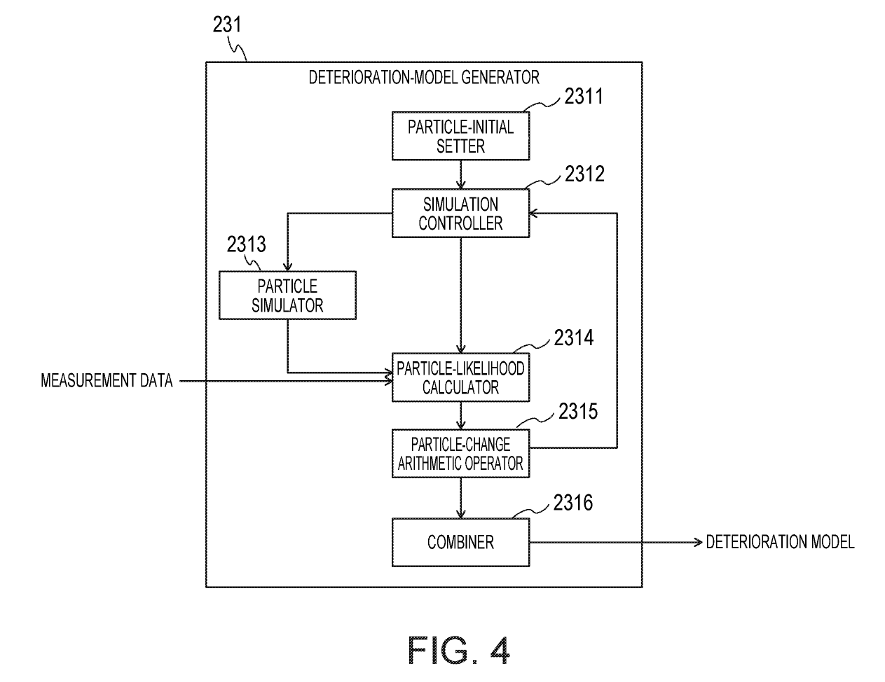

FIG. 4 is a block diagram showing an example of a schematic configuration of the deterioration-model generator 231 in the case in which the particle filter is used as the estimation method. The deterioration-model generator 231 in this case includes a particle-initial setter 2311, a simulation controller 2312, a particle simulator 2313, a particle-likelihood calculator 2314, a particle-change arithmetic operator 2315, and a combiner 2316.

The particle-initial setter 2311 sets initial values of components and weights of the respective particles at the initial time. It is assumed that the initial value of the components is 0 and the initial value of the weights is 1. However, the initial values may be other values.

The simulation controller 2312 sends values of the components and the weights of the respective particles to the particle simulator 2313 and instructs the particle simulator 2313 to execute a simulation.

The particle simulator 2313 calculates predicted values of the components of the respective particles at the time t+1 using a random number and a model formula (a state equation) decided in advance.

The particle-likelihood calculator 2314 calculates likelihoods on the basis of differences between the predicted values of the respective particles at the time t+1 calculated by the particle simulator 2313 and measured values of measurement data at the time t+1.

As a calculation method for a likelihood, for example, there is a method of normalizing, assuming that noise based on a Gaussian distribution is included in an observed value, a Euclidean distance between a measured value of measurement data and a predicted value of the particle simulator 2313. However, the calculation method is not particularly limited.

The particle-change arithmetic operator 2315 sets, as weight values of the respective particles, the likelihoods of the respective particles calculated by the particle-likelihood calculator 2314. Then, The particle-change arithmetic operator 2315 performs re-sampling. The re-sampling means that the respective particles are duplicated or extinguished on the basis of the weight values and then a new particle group is generated. Incidentally, since the particles are duplicated by the number of the extinguished particles, the number of particles is fixed.

As a method of the re-sampling, the duplication and the extinction are performed on the respective particles on the basis of a selection probability Ri, which is a value (weight i/Σ weigh i) obtained by dividing the weight i of the particle pi by a sum of the weights of all the particles. Then, n particles present after the end of the re-sampling are set as a set of new particles.

The particle-change arithmetic operator 2315 changes values of components of particles included in a range sectioned in advance at a fixed length with respect to values of all components of all the particles of the new particle group to values decided in advance within the range. This is to determine a value of a probability density distribution according to the number of particles. The weights of the respective particles are set to 1. In this way, a particle group at the time t+1 is generated.

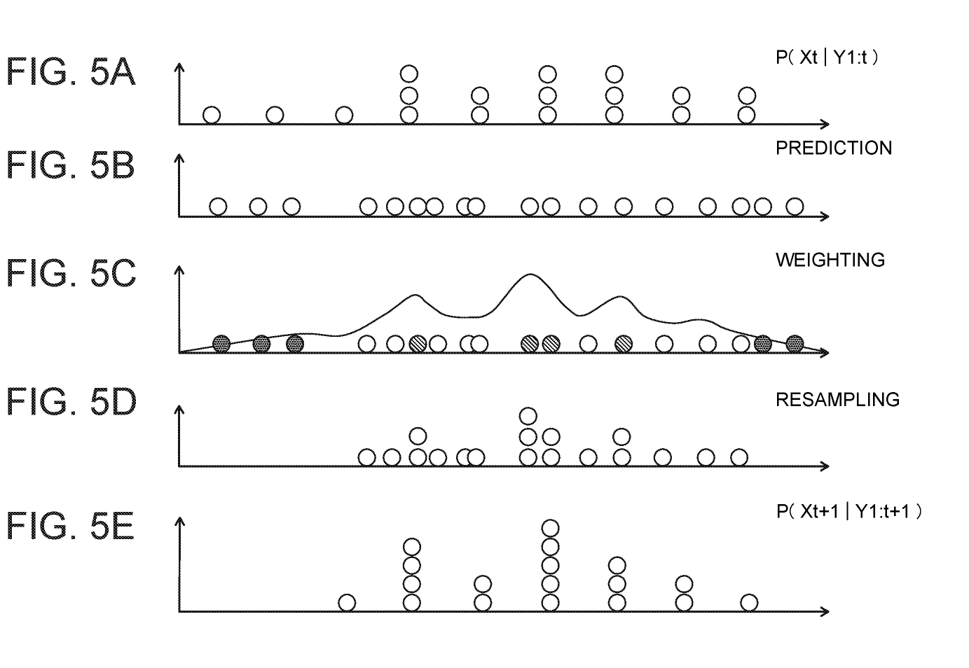

FIGS. 5A to 5E are diagrams showing contents of processing of the particle filter. The horizontal axis represents a probability variable x1 and the vertical axis represents a probability density.

FIG. 5A shows a distribution of a particle group at the time t. Display of particles on other particles indicates that, for convenience, there are a plurality of particles having the same value of x1.

FIG. 5B is a distribution obtained by predicting, with a simulation, a distribution of the particles at the time t+1.

FIG. 5C is a graph of a likelihood and a diagram in which weights of the particles are classified by colors. The weights of the respective particles are determined on the basis of the magnitude of the likelihood indicated by a curve. It is assumed that a determination standard for the magnitude of the likelihood is decided in advance. The particles having small likelihoods are shown in black, the particles having large likelihoods are shown in hatching, and the other particles are shown in white.

FIG. 5D shows a result of re-sampling. The black particles having the small likelihoods disappear. The hatched particles having the large likelihoods are duplicated. Incidentally, the number of particles to be duplicated may be different depending on weights. For example, two particles of the particle having the largest likelihood in FIG. 5C are duplicated in FIG. 5D.

FIG. 5E shows a distribution of the particle group at the time t+1. According to adjustment for setting values of all the particles present within a fixed section to a fixed value, a plurality of particles having the same value are present. A shape of a probability density distribution at the time t+1 is obtained.

By repeating this processing until the present time, a posteriori probability density distribution at the present time is finally calculated. Calculation processing for a posteriori probability density distribution is cyclically performed, whereby time-series data of posteriori probability density distributions is calculated.

The combiner combines values of the posteriori probability density distributions at the respective times as transition data and generates a deterioration model. For example, the combiner joins averages of the posteriori probability density distributions at the respective times to generate average expected performance.

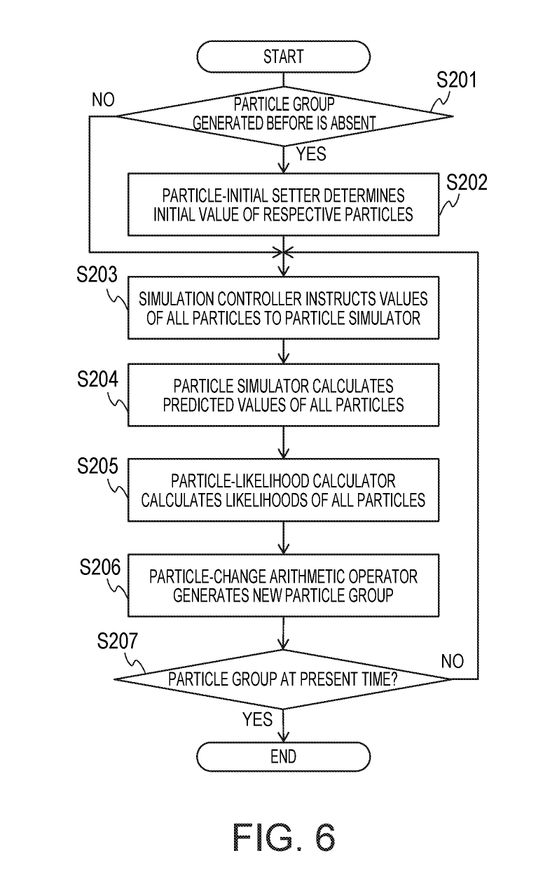

FIG. 6 is a flowchart of estimation processing for an internal parameter by the particle filter. This flow corresponds to S101 of the flow of the deterioration-model generation processing shown in FIG. 3 in the case in which an internal parameter is estimated by the particle filter.

The particle-initial setter 2311 confirms whether a particle group generated before is present in estimation parameters for generating a probability density distribution (S201). When there is the particle group, the particle-initial setter 2311 shifts to processing in S203. When there is not the particle group, the particle-initial setter 2311 determines initial values of respective particles (S202). It is assumed that the number of particles is decided in advance. However, the particle-initial setter 2311 may determine the number of particles at this time.

The simulation controller 2312 sends values of components of all the particles to the simulator 14 (S203). The particle simulator 2313 performs a simulation on all the acquired particles and calculates predicted values of the respective particles at the next time (S204).

The particle-likelihood calculator 2314 acquires the predicted values from the simulation controller 2312 and acquires measurement data from the measurement-data storage 212 and calculates likelihoods of the respective particles on the basis of the predicted values and the measurement data (S205).

The particle-likelihood calculator 2314 performs re-sampling and adjustment of values of the respective particles and generates a new particle group (S206). The particle-likelihood calculator 2314 confirms whether the generated new particle group is a particle group at the present time (S207). When the generated new particle group is not the particle group at the present time (NO in S207), the flow returns to the processing in S203. When the generated new particle group is the particle group at the present time (YES in S207), the flow ends. A probability density distribution is an estimated value (a range) of the internal parameter.

The building-model processor 3 is explained now. The building-model processor 3 manages various data (building data) concerning a building including a building model. The building-model processor 3 extracts and processes the building model on the basis of predetermined information to thereby generate a building model used for creation of an equipment operation plan.

In the building-data storage 31 of the building data manager, building data of various buildings are stored in advance. As the stored building data, there are, for example, CAD data such as a BIM model (Building Information Model).

The building data such as the BIM model includes an object, attribute information concerning an attribute of the object (a building attribute), and relation information representing a relationship with other objects. As the object, there are, for example, objects representing spaces, members (components), equipment, and the like configuring a building. The objects include information concerning shapes such as position coordinates of vertexes. The spaces represent spaces (rooms) surrounded by floors, walls, ceilings, imaginary partitions, and the like. Even when a space is not partitioned by a door and the like and there is no building member serving as a boundary of the space, it may be assumed that an imaginary partition is present. The spaces include both of a plane and a solid. As parts or components of the building, there are, for example, windows, columns, and stairs. The equipment only has to be apparatuses present in the building such as air-conditioners, lights, sensors, and wireless access points.

As the attribute information, there are, for example, a name, an area, a volume, a material, a quality of the material, performance, a user, and a state of the object and a floor where the object is present. As the relation information, there are a structural relation, a configuration relation, a connection relation, and the like.

Incidentally, information used for the machining processing only has to be included in the building data. Information not used for the machining processing does not have to be included in the building information. For example, if attributes of a material are unnecessary for the machining processing, values of the attributes of the material may be empty. The building data may be generated by the BIM software or may be edited or created anew for the spatial-information generation apparatus. In the following explanation, it is assumed that a BIM model is processed. However, the building data is not limited to the BIM model and only has to be building data including necessary information.

The building-model extractor 32 of the building data manager determines that a building similar to a building in which an operation target is set is a similar building. The building-model extractor 32 acquires, from the building-data storage 31, a building model related to the similar building as a building model of the operation target. Incidentally, a result of the extraction by the building-model extractor 32 may be passed to the acquirer 12 or may be stored in the extraction-result storage 33.

A determination condition for determining whether or not buildings are similar may be optionally decided. For example, the building-model extractor 32 determines that buildings are similar buildings for a first building, the buildings including objects, any one of attributes, shapes, or structures of which coincide or are similar to an object in the first buildings.

For example, the building-model extractor 32 may compare attributes of building data and confirms whether both the attributes coincide. Even if both the attributes do no coincide, when a relation between both the attributes is registered in similar relation data decided in advance indicating a similar relation, the building-model extractor 32 may determine that both the attributes are similar. When both the attributes are represented by values and a difference between the values of both the attributes is equal to or smaller than a threshold, the building-model extractor 32 may determine that both the attributes are similar.

For example, focusing on the shapes of plane objects such as walls or bottom surfaces, when the shapes of parts or the entire plane objects coincide or are similar, the building-model extractor 32 may determine that both the shapes coincide or are similar.

Focusing on directions of opening sections such as windows or doors, directions of decided direction axes, or the like, the building-model extractor 32 may determine whether both the structures coincide or are similar according to whether the directions coincide or are within a predetermined range.

Besides, for example, concerning the shapes, the building-model extractor 32 may determine using a well-known shape determination method whether both the buildings coincide or are similar. Concerning the structures, the building-model extractor 32 may determine whether both the buildings coincide or are similar using a well-known BIM model attribute search method such as a BIMQL (Building Information Model Query Language). For example, it is conceivable to adopt a method of representing information concerning the buildings in tree structures linked in a semantic relation and calculating similarity of the tree structures according to a TED (Tree Edit Distance).

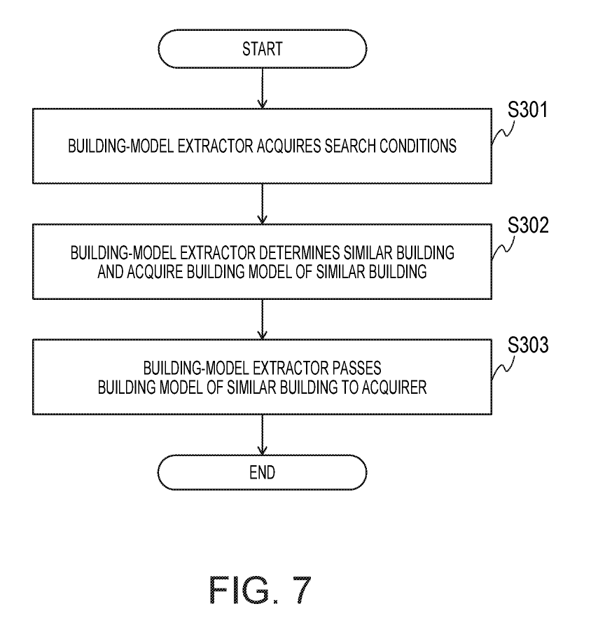

FIG. 7 is a flowchart of building-model extraction processing. It is assumed that building data is already recorded in the building-data storage 31 of the building-model processor 3.

The building-model extractor 32 acquires search conditions from the acquirer 12 (S301). The building-model extractor 32 searches through the building-data storage 31, determines that a building having building data matching the search conditions is a similar building and acquires a building model of the similar building (S302). The building-model extractor 32 passes the acquired building model to the acquirer 12 (S303). The building-model extractor 32 may record the acquired building model in the extraction-result storage 33. The flow of the building-model extraction processing is as explained above.

The operation-draft-plan creation processor 1 is explained now. The operation-draft-plan creation processor 1 acquires, on the basis of given information, information necessary for creation of an operation draft plan from the deterioration-model processor 2 and the building-model processor 3 and then creates an operation draft plan.

The inputter 11 receives information concerning the operation draft plan. For example, as conditions for the operation draft plan to be created, there are, for example, the number of planned years of the operation draft plan and an implementation deadline of maintenance work. When there is a contract term for an operation target and the operation target has to be returned before the contract term, an operation draft plan for updating the operation target before the contract term is created. Besides, there are, for example, expenses for respective kinds of maintenance work and type candidates of new equipment and the like in the case of replacement of equipment and the like.

The inputter 11 receives information for acquiring a deterioration model. As the information for acquiring a deterioration model, there is search keyword information related to a use case example of an operation target or space data, measurement target data, measurement data, feature value data, and incident data included in ontology for using ontology of the operation target. The use case example of the operation target may be acquired from the ontology storage 221 or the deterioration-model storage 233 on the basis of, for example, a use condition of a similar measurement target or building rather than being received from the inputter 11.

The inputter 11 receives information for acquiring a building model. As the information for acquiring a building model, there is, for example, information concerning attributes of a building such as area, volume, a material, a quality of the material, performance, a use, and a state of the building.

The acquirer 12 acquires the deterioration model and the use case example from the deterioration-model storage 233. Information concerning the use case example is not particularly limited as long as the information is information for specifying a way of use of the operation target. For example, when the operation target is an air conditioner, the information may be an ON/OFF time of the air conditioner, a change in a set temperature, room temperatures of respective rooms, an outdoor temperature, and the like for each date and time.

The operation-draft-plan creator 13 creates an operation draft plan. Prediction of performance such as economy (a sum of operation cost and maintenance cost) and comfort of the entire operation target, which are bases of an operation draft plan, is calculated by the simulator 14 performing a simulation on the basis of the use case example, the deterioration model, and the building model. The operation-draft-plan creator 13 sets the use case example, the deterioration model, and the building model in the simulator 14. The operation-draft-plan creator 13 changes content, a period, and the like of maintenance work as parameters of the simulation and then causes the simulator 14 to perform the simulation. Consequently, simulation results with different contents, periods, and the like of the maintenance work are generated.

Incidentally, the use case example used in the simulation may be created with reference to, as an example, use exannples(“Commercial Prototype Building Modelsin the following”) disclosed in the Web page(“https://www.energycodes.gov/connnnercial-prototype-building-models”) of the United States Department of Energy.

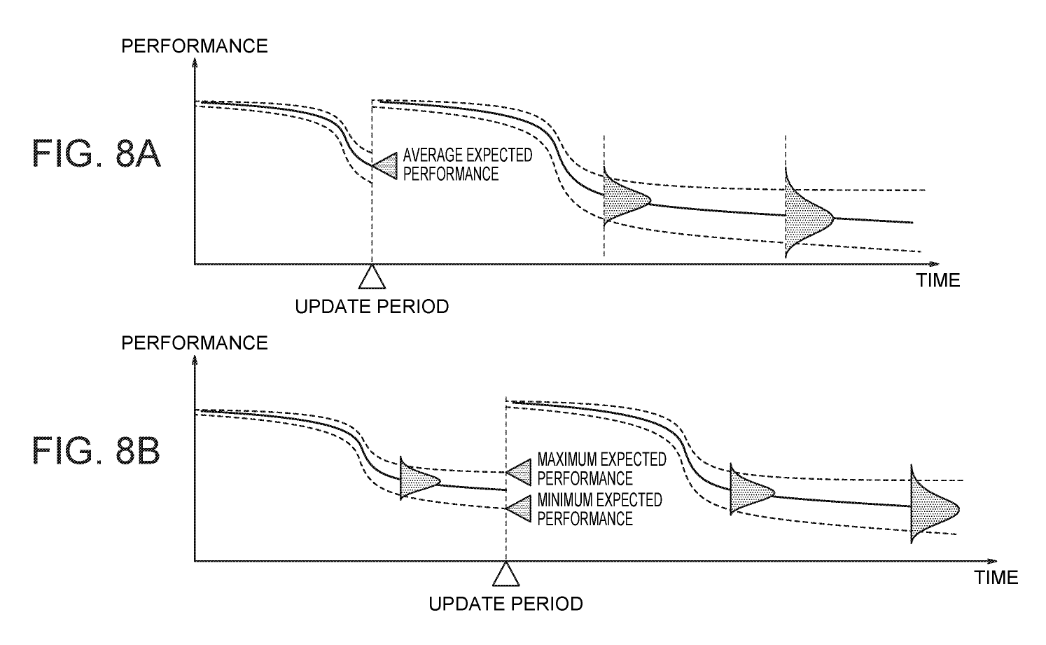

FIGS. 8A and 8B are diagrams showing examples of operation draft plans. In FIGS. 8A and 8B, implementation periods of maintenance work performed on an operation target are indicated by white triangles on the horizontal axis (the time axis). Performance is indicated on the vertical axis as an index for evaluating the operation draft plan. As shown in FIGS. 8A and 8B, transitions of the performance before and after maintenance work implementation are shown in the operation draft plans. Consequently, it is possible to view effects of the maintenance work.

In an operation draft plan 1 (a plan 1) shown in FIG. 8A, since an update period is early, deterioration in the performance before the update period is small. In an operation draft plan 2 (a plan 2) shown in FIG. 8B, since the update period is late, although there is variation in expected performance, deterioration in the performance is large in the update period. Therefore, in the plan 2, it is likely that a dissatisfaction of a user or the like who uses equipment or the like increases immediately before the update period.

The operation-draft-plan creator 13 creates the operation draft plans shown in FIGS. 8A and 8B and outputs the operation draft plans via the outputter 16. The operation-draft-plan creator 13 may output all the created operation draft plans. Alternatively, the operation-draft-plan creator 13 may output an operation draft plan satisfying conditions or an operation draft plan determined as optimum of the created operation draft plans.

For example, in the case of a condition that an average expected characteristic should not be equal to or smaller than a threshold, if an average expected characteristic of the plan 2 shown in FIG. 8B is equal to or smaller than the threshold, the plan 2 does not have to be output. For example, when a condition that maximum expected performance only has to be equal to or larger than a threshold is input, if maximum expected performance of the plan 2 is equal to or larger than the threshold, either one or both of the plan 1 and the plan 2 may be output.

Incidentally, in FIGS. 8A and 8B, it is assumed that the maintenance work is updated to an apparatus of the same type. Therefore, values of the performance after the update are the same as initial values. Use situations after the update are also the same. Therefore, the shapes of the graphs are also the same before and after the update. However, content of the maintenance work is not limited to the update. The use situations after the update may also be changed.

The operation target may be replaced with a different type by the update. In that case, a simulation result of the operation target and a simulation result of the different type only have to be joined. In a simulation of the different type, a deterioration model of the different type only has to be acquired in the same manner as the deterioration model of the operation target. In the operation draft plan in the case in which the operation target is replaced with the different type, unlike FIGS. 8A and 8B, the values of the performance index and the shapes of the graphs change. The use condition after the update may also be changed. For example, it may be assumed that the operation target is set in a different tenant and the use condition is changed. In that case, the simulation is performed using a building model and a use case example corresponding to the different tenant.

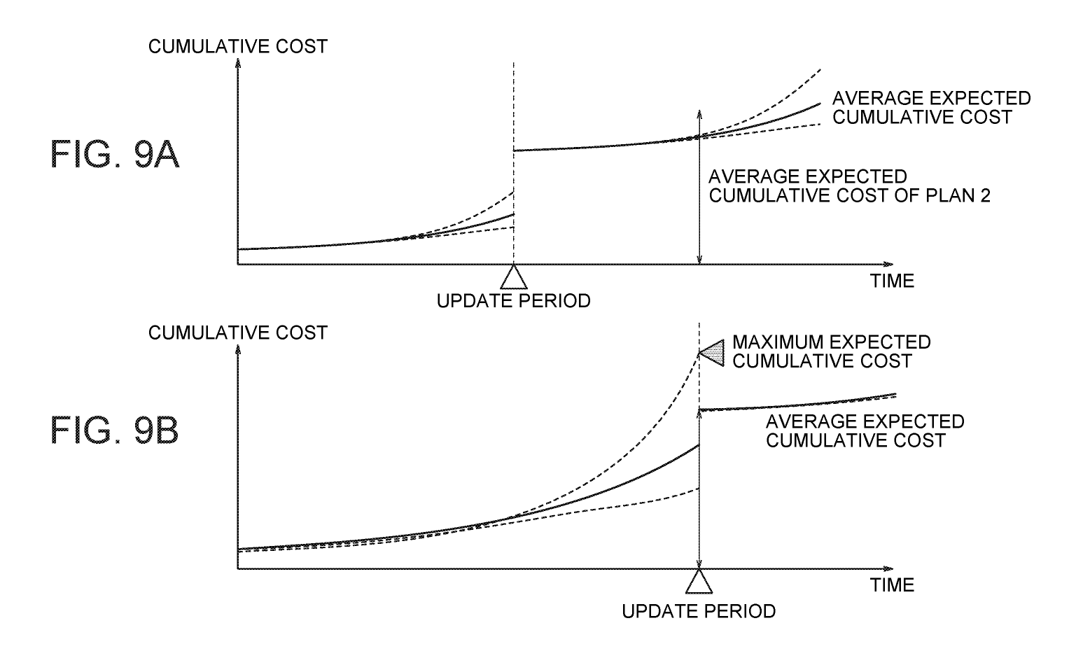

In FIGS. 8A and 8B, the performance is used as the index of the evaluation. However, an index other than the performance may be used. FIGS. 9A and 9B are diagrams showing other examples of the operation draft plans. In the examples shown in FIGS. 9A and 9B, cumulative cost is an evaluation index in the operation draft plans. The cumulative cost is represented by a sum of cost during update and operation cost of the operation targets to the present. FIG. 9A shows the plan 1 shown in FIG. 8A. FIG. 9B shows the plan 2 shown in FIG. 8B.

In the plan 2 shown in FIG. 9B, maximum expected cumulative cost is acceleratingly increased immediately before the update period. This indicates that power consumption cost and the like increase according to the deterioration in the performance. Consequently, average expected cumulative cost after the update of the plan 2 is larger than average expected cumulative cost after the update of the plan 1. Therefore, for example, in the case of a condition that an operation draft plan in which the average expected cumulative cost in the update period in FIG. 9B is the smallest is output, the plan 1 is output.

The operation-draft-plan storage 15 stores the operation draft plan created by the operation-draft-plan creator 13. The operation-draft-plan storage 15 may receive search conditions from the user or the like via the inputter 11 and output an operation draft plan matching the search conditions via the outputter 16.

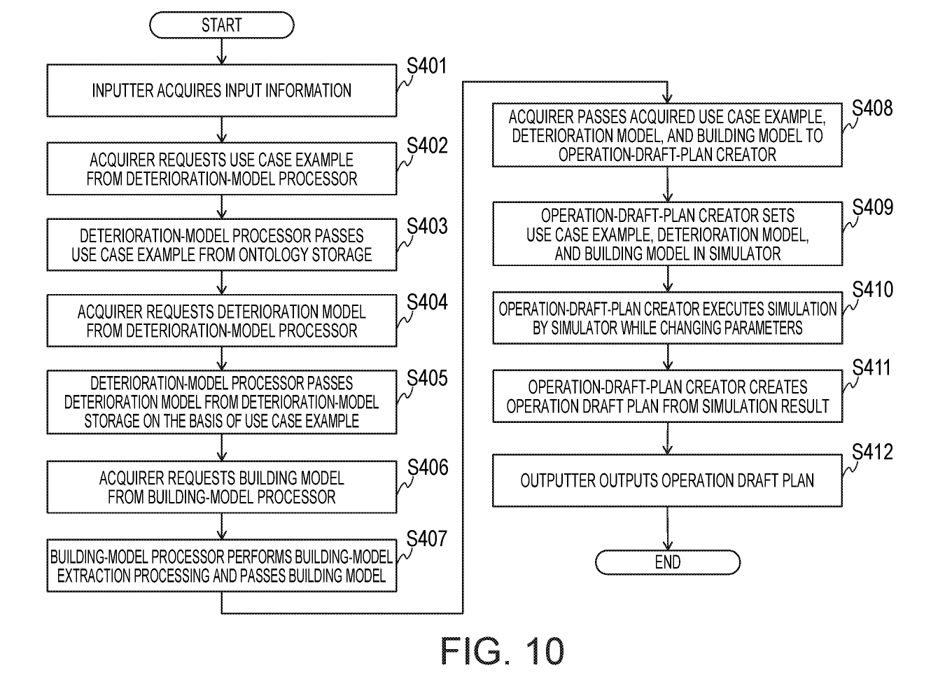

FIG. 10 is a flowchart of operation-draft-plan creation processing. It is assumed that a deterioration model is already generated and stored in the deterioration-model storage 233. It is assumed that building data is stored in the building-data storage 31 of the building-model processor 3.

The inputter 11 receives input information (S401). The inputter 11 passes necessary information to the acquirer 12. The acquirer 12 requests a use case example from the deterioration-model processor 2 on the basis of information such as a use condition of an operation target and a building in which the operation target is set (S402). Incidentally, although it is assumed that the use case example is acquired from the ontology storage 221, the acquirer 12 may acquire the use condition from the user or another system via the inputter 11. In that case, the processing in S402 is omitted. The deterioration-model processor 2 extracts, from the ontology storage 221, a use case example matching the information given from the acquirer 12 and passes the use case example to the acquirer 12 (S403). Incidentally, the processing in S402 and S403 may be directly performed between the acquirer 12 and the ontology storage 221 or may be performed via the ontology acquirer 232.

The acquirer 12 requests a deterioration model from the deterioration-model processor 2 on the basis of the operation target and the acquired use case example (S404). The deterioration-model processor 2 extracts, from the deterioration-model storage 233, a deterioration model matching information given from the acquirer 12 and passes the deterioration model to the acquirer 12 (S405). Incidentally, the deterioration-model processor 2 may continuously perform the processing in S405 on the basis of the use case example extracted in the processing in S403 and pass the use case example and the deterioration model to the acquirer 12 at a time. In this case, the processing in S404 is omitted.

The acquirer 12 requests a building model from the building-model processor 3 on the basis of information concerning the building in which the operation target is set (S406). The building-model processor 3 performs the building-model extraction processing shown in FIG. 7 and passes a building model to the acquirer 12 (S407).

The acquirer 12 passes the acquired use case example, the acquired deterioration model, and the acquired building model to the operation-draft-plan creator 13 (S408). The operation-draft-plan creator 13 sets the use case example, the deterioration model, and the building model in the simulator 14 (S409). The operation-draft-plan creator 13 causes, while changing parameters such as content of maintenance work and a period of the maintenance work, the simulator 14 to perform a simulation (S410). The operation-draft-plan creator 13 creates an operation draft plan on the basis of the acquired simulation result (S411).

The created operation draft plan is passed to the outputter 16. The outputter 16 outputs the operation draft plan (S412). The created operation draft plan may be passed to the operation-draft-plan storage 15 and stored in the operation-draft-plan storage 15. The flow of the operation-draft-plan creation processing is as explained above.

As explained above, according to the first embodiment, the operation draft plan is created using the measurement data of the measurement target similar to the operation target. In this case, by estimating, using the probability density distribution, the internal parameter that cannot be directly calculated from the measurement data, it is possible to predict deterioration in the performance and create an operation draft plan in which the implementation period of the maintenance work is appropriate.

By using the ontology in which the measurement data of the measurement target and the other data related to the measurement target are systemized, it is possible to search for, even with a simple keyword, the measurement target similar to the operation target and the use case example of the measurement target.

By using the building model of the building similar to the building in which the operation target is set, it is possible to create the operation draft plan even when detailed information of the building in which the operation target is set is absent or even when the building is under construction.

### Second Embodiment

In a second embodiment, unnecessary data is removed from a building model used for a simulation to simplify the building model and reduce a load of the simulation. For example, a specific building element such as a column or a building element satisfying a specific condition such as a wall in contact with the outdoor air may be excluded. An outer peripheral shape of a target space may be short-circuited or linearized. Explanation of similarities to the first embodiment is omitted.

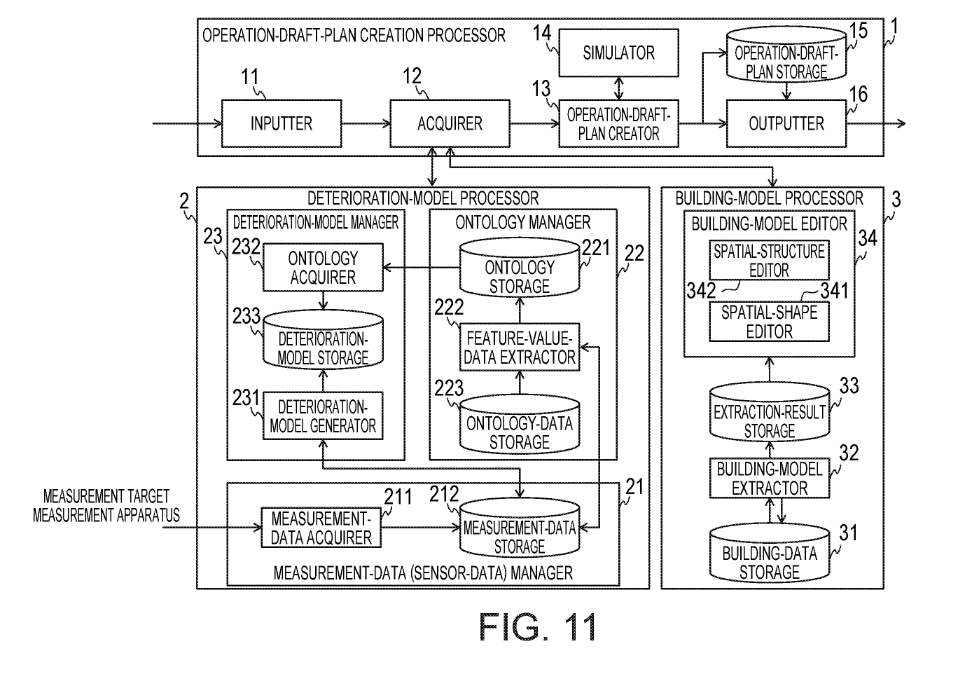

FIG. 11 is a block diagram showing an example of a schematic configuration of an operation-draft-plan creation apparatus according to a second embodiment. The second embodiment is different from the first embodiment in that the building-model processor 3 further includes a building-model editor 34. The building-model editor 34 includes a spatial-shape editor 341 and a spatial-structure editor 342.

The building-model editor 34 edits and simplifies a building model on the basis of parameters received from the acquirer 12. As the parameters received from the acquirer 12, there are a target to be edited, a portion or a range to be edited, a machining level, a machining method, and the like. As the machining level, for example, a threshold of area, volume, or the like lost by the machining is conceivable.

The spatial-shape editor 341 of the building-model editor 34 performs machining concerning a shape of a building model. The machining concerning a shape is, for example, simplification of a shape of an outer periphery, an inner periphery, or the like of a room or the like in a building. For example, the spatial-shape editor 341 simplifies a shape of a portion concerning a designated element of the shape of the building model or a portion of an element of a designated type. Consequently, the spatial-shape editor 341 reduces the number of sides concerning the element of a plane.

The spatial-shape editor 341 acquires, from a building model acquired from the building-model extractor 32 or the extraction-result storage 33, a plane object, which is a part of the building model, and generates a shape of the plane object. In this specification, the plane object is referred to as machining surface (reference plane).

The spatial-shape editor 341 simplifies a shape of a portion concerning a designated element or a portion of an element of a designated type from a shape of the generated machining surface. Consequently, the spatial-shape editor 341 reduces the number of sides concerning the element of the machining surface. In this specification, this simplification is referred to as element simplification.

The spatial-shape editor 341 simplifies a convex section or a concave section smaller than a threshold present on an adjacent side on which the acquired building model and a building model adjacent to the building model are in contact on the machining surface. In this specification, this simplification is referred to as linearization.

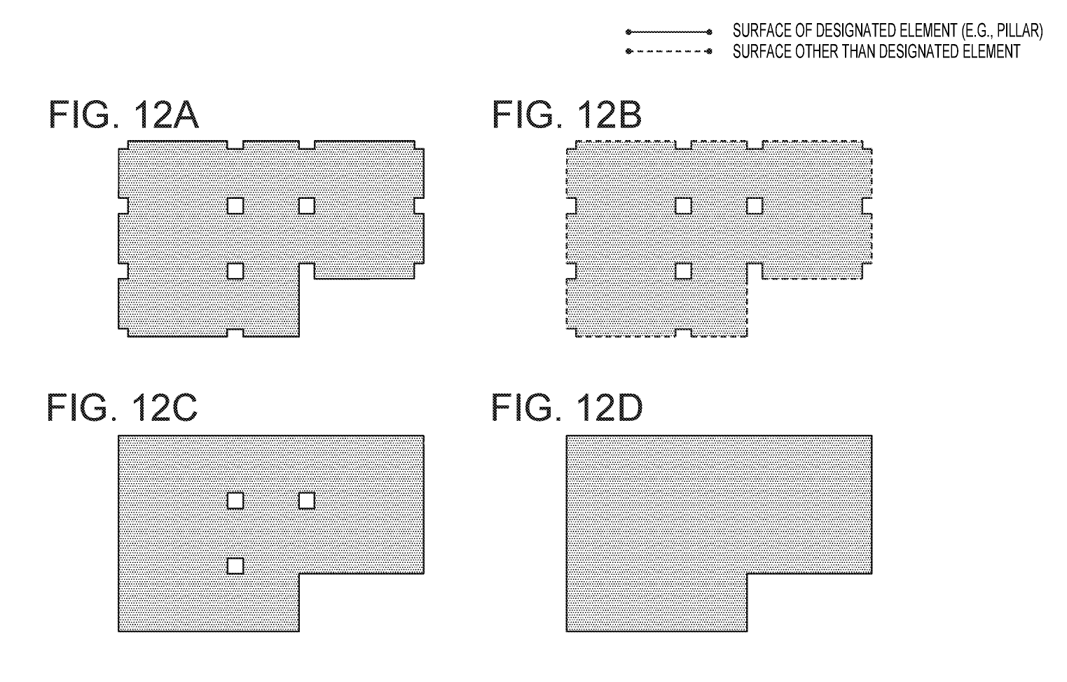

FIGS. 12A to 12D are diagrams showing an example of the element simplification. FIG. 12A is a diagram showing a machining surface before machining. In FIG. 12B, sides related to columns, which are designated elements in this example, are indicated by solid lines and lines other than the columns are indicated by dotted lines. FIG. 12C is a diagram showing a halfway process of simplification processing. FIG. 12D shows the machining surface after the machining. Alphabetical order of FIG. 12 indicates the order of transition. The same applies to the subsequent figures.

On the machining surface before the machining, recesses (concave sections) due to the columns are present in the outer peripheral portion and free spaces due to the columns are present on the inside. It would be possible that such recesses, spaces, and the like are unnecessary in a simulation of the simulator 14. For example, it would be possible that information concerning the free spaces on the inside due to the columns are necessary but the recesses due to the columns on the outer peripheral portion are unnecessary. Therefore, the spatial-shape editor 341 deletes designated unnecessary information that should be omitted.

The spatial-shape editor 341 distinguishes a surface concerning the columns of the designated elements and the other surfaces and simplifies the surface concerning the columns. First, the columns in the outer periphery are simplified. In FIG. 12C, the concave sections in the outer periphery have disappeared. The free spaces due to the columns on the inside are simplified. In FIG. 12D, all surfaces concerning the columns are deleted. In this way, the spatial-shape editor 341 simplifies the machining surface.

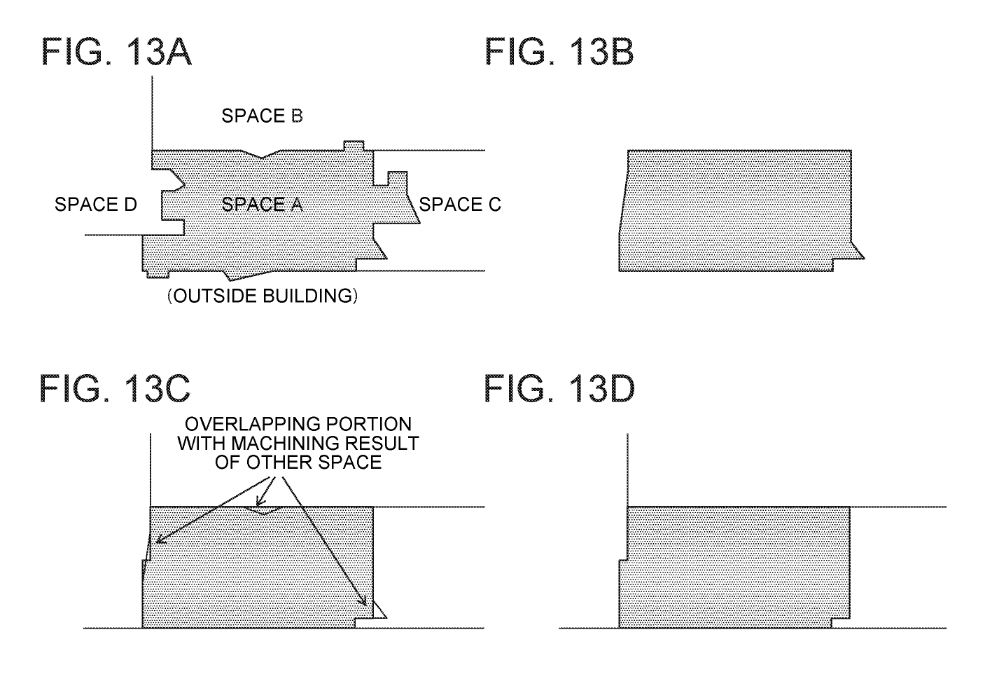

FIGS. 13A to 13D are diagrams showing an example of linearization. Convex sections and recessed sections smaller than a threshold decided in advance present in the outer periphery of a space are linearized and an information amount of an object is reduced. FIG. 13A is a diagram showing a machining surface before linearization processing. FIG. 13B and FIG. 13C show halfway processes of the linearization processing. In FIG. 13B, convex sections and concave sections are simplified on the basis of a method decided in advance. FIG. 13C shows overlapping portions of simplified spaces and other spaces. Simplification processing is further performed concerning the overlapping portions. FIG. 13D shows a machining surface after simplification. In this way, the spatial-shape editor 341 linearizes the machining surface.

The spatial-shape editor 341 performs one or both of the element simplification and the linearization to thereby generate a simplified machining surface from which unnecessary information is excluded. Consequently, it is possible to reduce a load of processing of a simulation. It is also possible to reduce a time period until calculation of a calculation result. Details of the processing of the spatial-shape editor 341 are explained below.

The spatial-structure editor 342 performs division or aggregation of the machining surface to simplify the building model on the basis of a designated machining method. In this specification, the division means dividing the machining surface into a plurality of divided pieces. The aggregation means combining a plurality of machining surfaces into one.

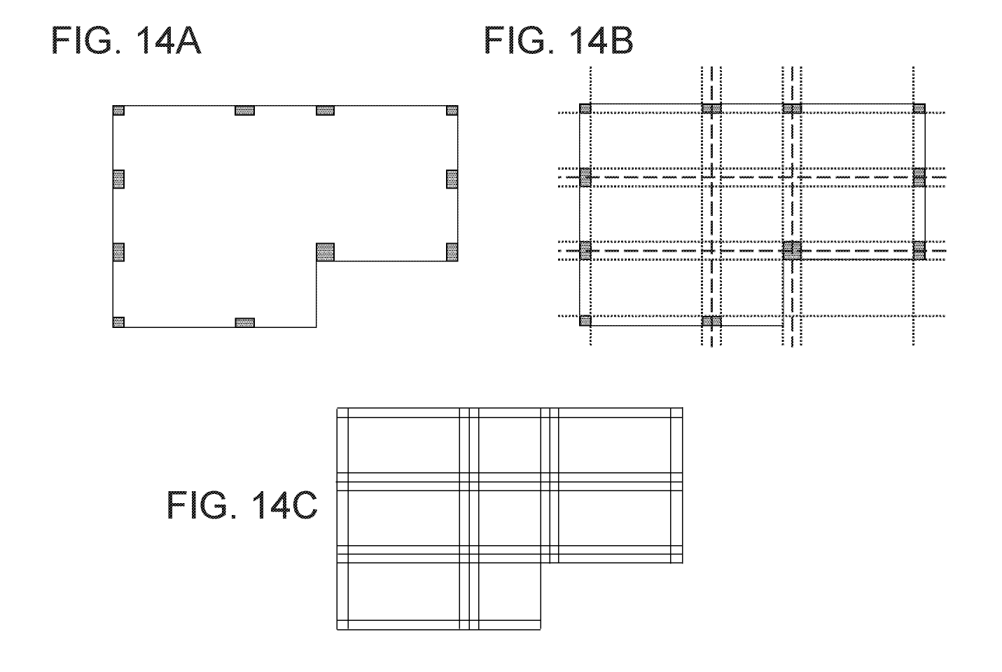

FIGS. 14A to 14C are diagrams for explaining the division. FIG. 14A is a diagram showing a machining surface to be simplified. FIG. 14B is a diagram in which division lines are drawn on the machining surface. FIG. 14C is a diagram showing generated divided pieces. Black squares in contact with the outer periphery of the machining surface shown in FIG. 14A indicate columns in contact with the outer periphery. The spatial-structure editor 342 generates the division lines on the basis of components such as columns. The spatial-structure editor 342 divides one plane into a plurality of divided pieces.

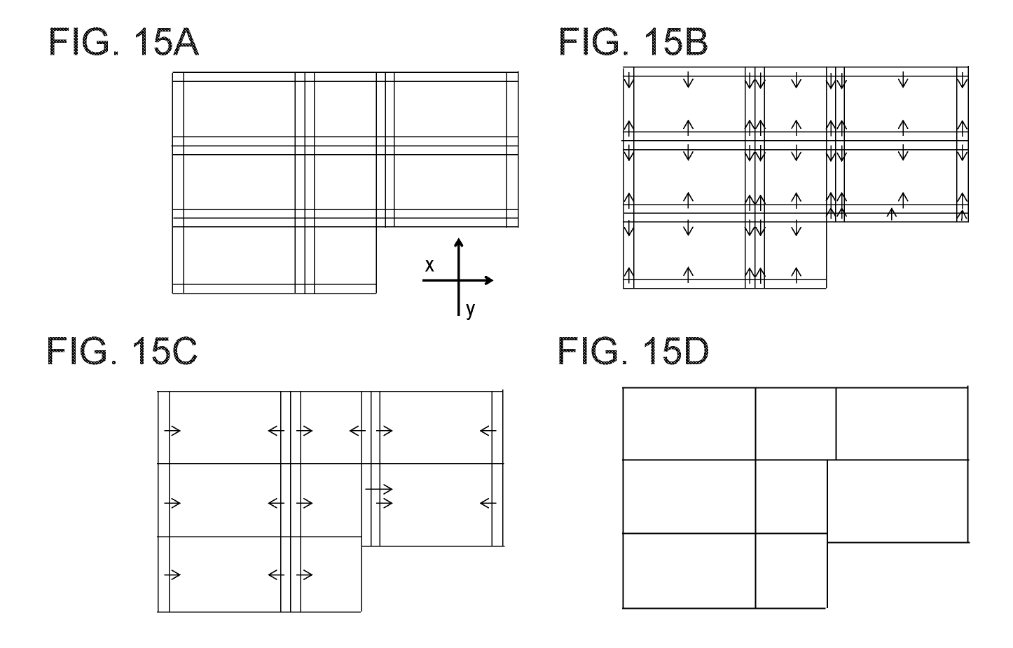

FIGS. 15A to 15D are diagrams for explaining reconfiguration of the divided pieces. FIG. 15A is the same as the diagram shown in FIG. 14C and shows the divided pieces. FIG. 15B indicates that the divided pieces at ends of arrows are absorbed by the divided pieces at tips of the arrows. FIG. 15C shows the reconfigured divided pieces and shows, with arrows, directions of further reconfiguration. FIG. 15D shows a result of the reconfiguration. In this way, the reconfiguration of the divided pieces eliminates small divided pieces in this way.

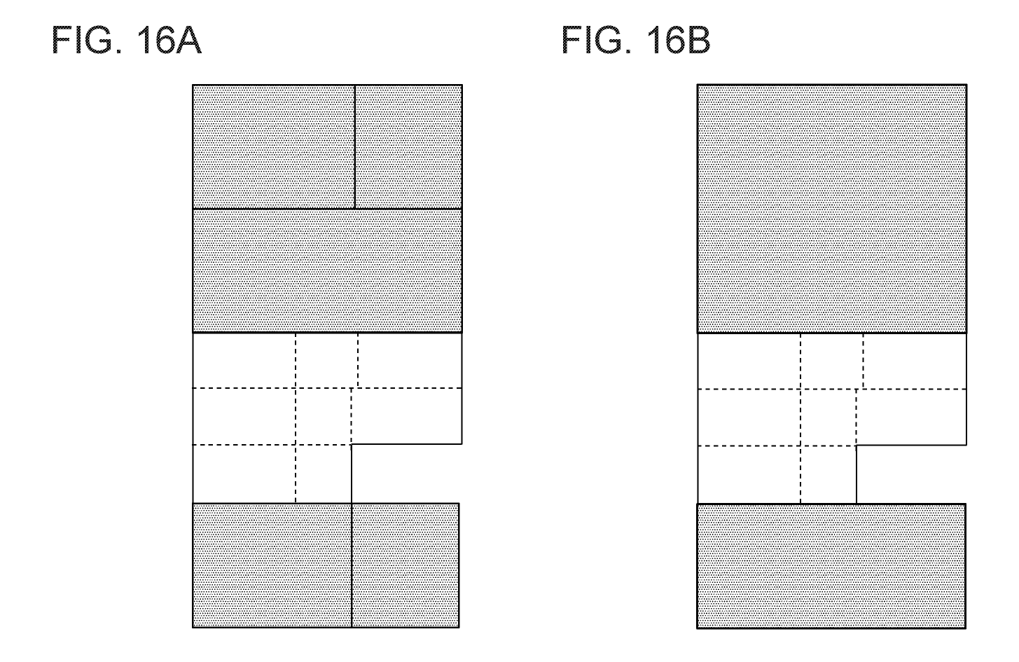

The aggregation will be s explained. FIGS. 16A and 16B are diagrams for explaining the aggregation. Portions surrounded by solid lines in FIG. 16A are machining surfaces. Dotted lines are division lines. The machining surfaces indicated by gray are machining surfaces not designated as division targets. The machining surfaces indicated by white are machining surfaces designated as division targets in which divided piece are generated. In this way, when there are a plurality of machining surfaces, the aggregation is performed targeting the machining surfaces that are not the division targets.

The spatial-structure editor 342 acquires machining surfaces, which are considered to be in an adjacent relation because parts of the outer peripheries of the machining surfaces are adjacent or shared, and combines the machining surfaces such that the outer periphery of the machining surfaces is the longest. If a plurality of adjacent machining surfaces are considered one group, the machining surfaces can be regarded as divided pieces. In the same manner as the reconfiguration of the divided pieces, the aggregation can be performed. In FIG. 16A, if three machining surfaces on the upper side among the machining surfaces indicated by white are set as one group and two machining surfaces on the lower side among the machining surfaces indicated by white are set as another one group, as shown in FIG. 16B, the machining surfaces are aggregated.

The division or the aggregation is performed in this way, whereby the building model is simplified. Details of the processing of the spatial-structure editor 342 are explained below.

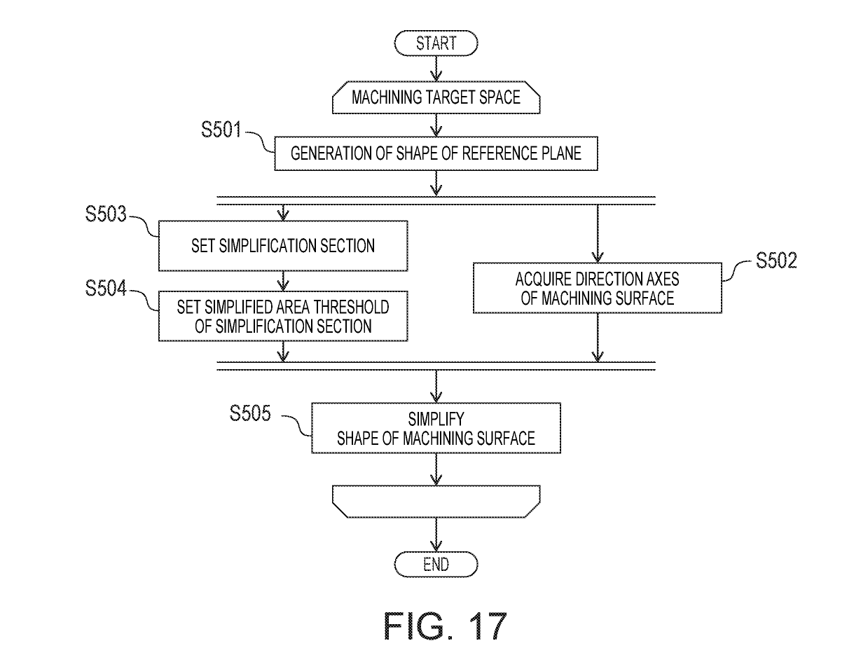

Details of spatial-shape machining processing are explained now. FIG. 17 is a flowchart of the spatial-shape machining processing. The spatial-shape editor 341 performs the processing on all machining target building models. First, the spatial-shape editor 341 performs generation of a shape of a machining surface (S501). Subsequently, after the generation of the machining surface, the spatial-shape editor 341 acquires direction axes of the machining surface (S502). The direction axes of the machining surface serve as a reference axis in performing machining.

The spatial-shape editor 341 sets a simplification section (S503) and a simplified area threshold in the simplification section (S504). The simplification section is a target section of simplification of a shape generated by dividing a side, which forms the machining surface, into a plurality of sections. The simplified area threshold indicates an upper limit value of an area deleted by the simplification by the spatial-shape editor 341. The simplified area threshold prevents an area from being excessively deleted by the simplification.

The acquisition of the direction axes (S502) may be performed in parallel to the setting of the machining section and the simplified area threshold (S503 and S504) or may be performed before or after the setting of the machining section and the simplified area threshold. After the acquisition of the direction axes (S502) and the setting of the machining section and the simplified area threshold (S503 and S504) are completed, the spatial-shape editor 341 simplifies the shape of the machining surface (S505). The simplification may be one or both of the element simplification and the linearization. The schematic flowchart of the spatial-shape machining processing is as explained above.

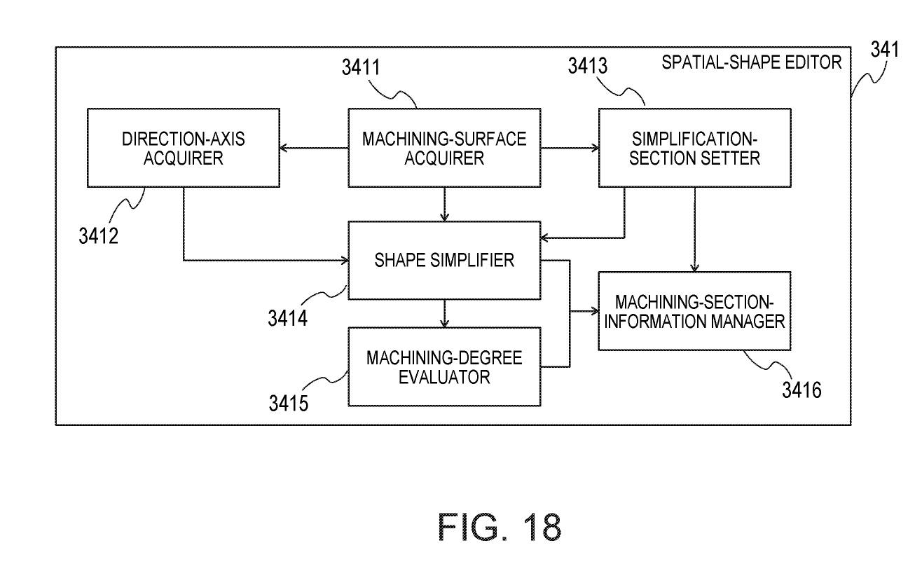

Further, details of the spatial-shape editor 341 are explained now. FIG. 18 is a block diagram showing an example of a schematic configuration of the spatial-shape editor 341. The spatial-shape editor 341 includes a machining-surface acquirer 3411, a direction-axis acquirer 3412, a simplification-section setter 3413, a shape simplifier 3414, a machining-degree evaluator 3415, and a machining-section-information manager 3416.

The machining-surface acquirer 3411 generates a shape of a machining surface. A surface to be the machining surface may be decided in advance or may be designated from the acquirer 12. In the construction field, the machining surface is often a floor surface (a bottom surface). The machining surface is explained as the floor surface.

When the floor surface is set as the machining surface, the machining-surface acquirer 3411 detects the floor surface on the basis of the attribute information and the relation information of the building model. After detecting the floor surface, the machining-surface acquirer 3411 generates a shape of the machining surface on the basis of a generation method decided in advance. As the generation method, for example, it is conceivable to adopt a method of acquiring two-dimensional coordinates of all vertexes of all elements concerning the floor surface, calculating sides connecting the vertexes, and generating a shape forming a largest closed loop. As another method, only vertexes concerning the floor surface are extracted from all vertexes of all elements concerning side surface surrounding a space, for example, walls and a shape forming a largest closed loop is generated on the basis of two-dimensional coordinates of the vertexes and sides connecting the vertexes. Incidentally, for example, when there is an error in a coordinate, a connection relation among the walls may be taken into account.

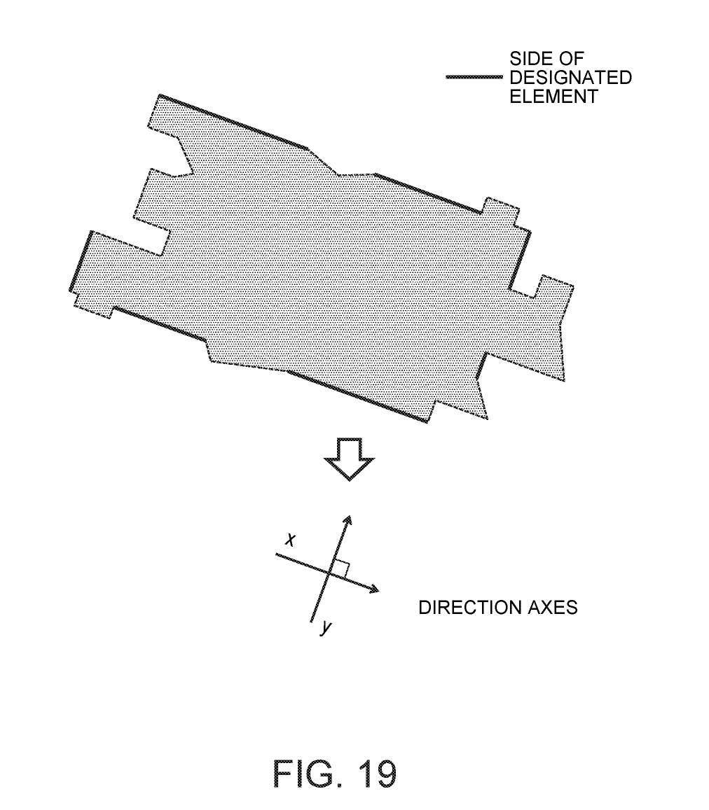

The direction-axis acquirer 3412 acquires direction axes for each machining surface. FIG. 19 is a diagram showing an example of a method of acquiring direction axes. The direction-axis acquirer 3412 acquires directions (vectors) of sides related to elements designated as direction references among the sides forming the machining surface. In FIG. 19, the sides related to the designated elements are indicated by solid lines. After grasping the directions of the sides in all the sides of the designated elements, the direction-axis acquirer 3412 confirms whether there is a combination of orthogonal sides. When a set of orthogonal sides is found, the direction-axis acquirer 3412 sets the set of the sides as direction axes. When a plurality of sets of orthogonal sides are found, the direction-axis acquirer 3412 may sets a plurality of direction axes or may select one direction axis.

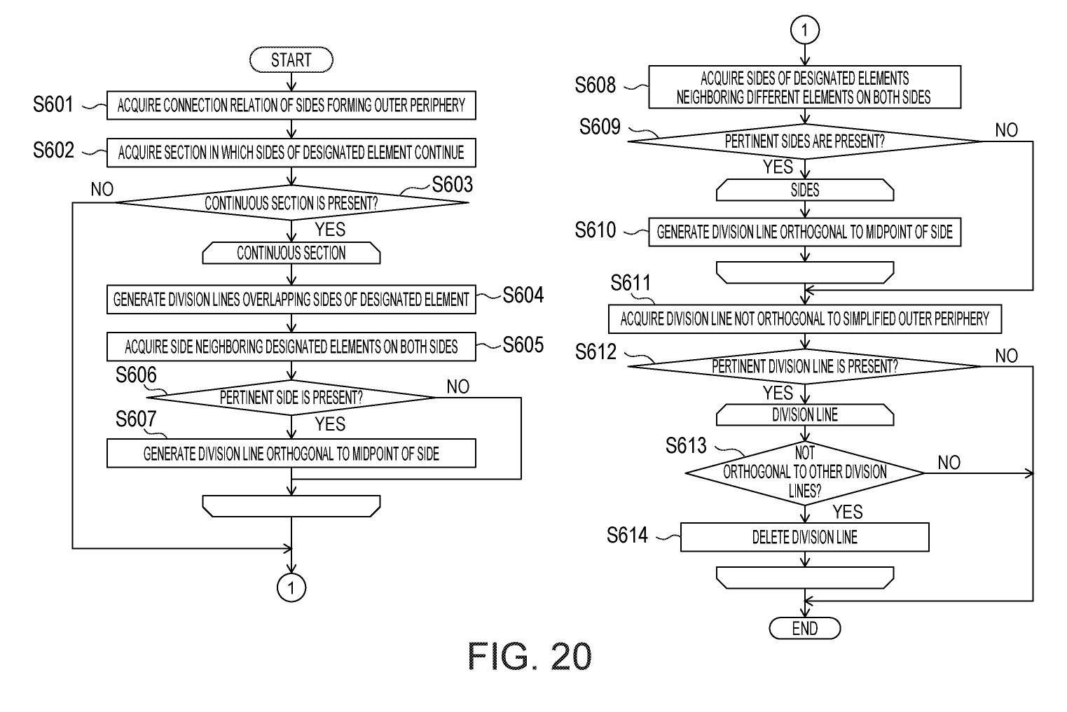

FIG. 20 is a flowchart for generating division lines. The direction-axis acquirer 3412 acquires a connection relation of sides forming the outer periphery of a machining surface (S601) and acquires, on the basis of the connection relation, sections in which sides of designated elements such as columns continue (S602). When continuous sections are present (YES in S603), the direction-axis acquirer 3412 performs generation of division lines with respect to the respective continuous sections. Specifically, the direction-axis acquirer 3412 generates division lines overlapping the sides of the designated elements (S604). The direction-axis acquirer 3412 acquires a side neighboring designated elements on both sides (S605). The side means a side in a recessed portion of a concave section (a side not in contact with the outer periphery of the machining surface). If the side can be acquired (YES in S606), the direction-axis acquirer 3412 generates a division line orthogonal to a midpoint of the side (S607). Consequently, the direction-axis acquirer 3412 generates division lines of continuous sections.

When there is no continuous section (NO in S603) or after performing generation processing (S607) of division lines for all the continuous sections, the direction-axis acquirer 3412 acquires sides of designated elements neighboring different elements on both sides (S608).

If the sides can be acquired (YES in S609), with respect to the respective acquired sides, the direction-axis acquirer 3412 generates division lines orthogonal to a midpoint of the side (S610). When there is no relevant side (NO in S609) or after performing generation processing (S610) of division lines for all the acquired sides, the direction-axis acquirer 3412 acquires a division line not orthogonal to the outer periphery after simplification (S611). When there is no division line (NO in S612), the direction-axis acquirer 3412 ends the processing. After the division line is acquired (YES in S612), the direction-axis acquirer 3412 confirms whether the division line is orthogonal to another division line. When the division line is not orthogonal to another division line (YES in S613), the direction-axis acquirer 3412 deletes the division line (S614). Consequently, it is possible to delete an unnecessary division line that cannot be set as direction axes. When the confirmation and the deletion are finished for all the division lines, this flow ends.

When direction axes cannot be acquired by the method decided in advance explained above, for convenience, direction axes in an adjacent space are acquired. When the direction axes of the adjacent space cannot be acquired either, a search range is gradually expanded to find an acquirable space.

Incidentally, when the direction axes are generated, necessary designated elements only have to be designated from the acquirer 12 or the like.

The simplification-section setter 3413 sets (generates) simplification sections with respect to respective sides forming a machining surface on the basis of an adjacent relation with other spaces.

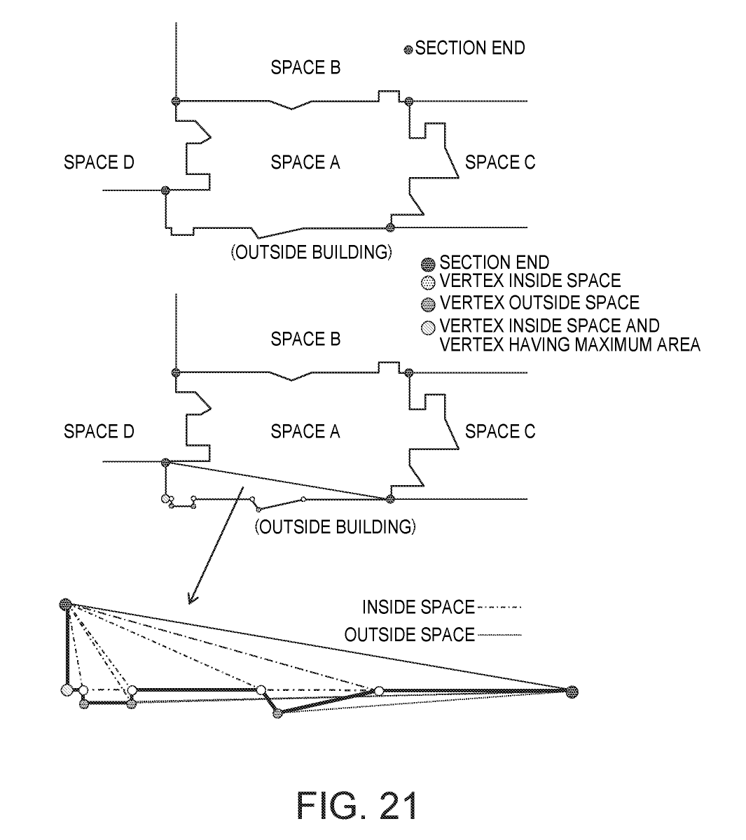

FIG. 21 is a diagram for explaining processing of simplification section setting. It is assumed that a space A, which is a machining target, is adjacent to the outside of a building and spaces B, C, and D. The simplification-section setter 3413 sets both ends of a section (a side) in which the target space A is adjacent to another space respectively as section ends. In FIG. 21, the section ends are indicated by black circles. Consequently, simplification sections of adjacent sides of spaces adjacent to each other coincide with each other in both the adjacent spaces. Even in the same side, if both ends of a simplification section are different, a machining result could be different. Consequently, results of machining processing performed on the respective spaces can have consistency in the adjacent sides.

The simplification-section setter 3413 acquires a section without an adjacent space, that is, a side facing the outside of the building and acquires vertexes present on the side. The simplification-section setter 3413 connects the acquired vertexes and two section ends adjacent to each other with connection lines and confirms whether two connection lines are present in a space. In FIG. 21, connection lines present in the space are indicated by alternate long and short dash lines and connection lines sticking out of the space are indicated by broken lines. Incidentally, when the connection lines are present on lines connecting the section ends, the connection lines are also regarded as being within the space. When both of two connection lines extended from a vertex are present in the space, the vertex is set as an intra-space vertex. In FIG. 21, intra-space vertexes are indicated by white circles and a circle hatched on the inside. When at least one of two connection lines extended from a vertex is not present in the space, the vertex is set as an extra-space vertex. In FIG. 21, extra-space vertexes are indicated by circles grayed on the inside.

The simplification-section setter 3413 adds, among the intra-space vertexes, an intra-space vertex having a maximum area of a range surrounded by lines connecting the intra-space vertex and the adjacent two section ends to section ends. In FIG. 21, the circle hatched on the inside indicates a vertex having a maximum area. The vertex added to the section ends is not deleted by the simplification processing.

After adding the section end as explained above, the simplification-section setter 3413 optionally selects one of the section ends as a base point, traces the outer periphery clockwise, and sets a section between the section end and the section end as a simplification section. Incidentally, the simplification-section setter 3413 traces the outer periphery clockwise but may trace the outer periphery counterclockwise. Incidentally, processing performed in the following explanation is based on the premise that the processing is performed clockwise. When the processing is set in counterclockwise, the direction of the processing is reversed.

The simplification-section setter 3413 generates machining section information for each of simplification sections. The machining section information includes information concerning the simplification section and information concerning machining processing performed on the simplification section.

The machining section information includes, for example, an ID of the simplification section, an ID and a position coordinate of a vertex present on the simplification section, a machining area threshold set for each of the simplification sections, the number of machining steps representing the order of performed machining processing (machining steps), an area of a part added or deleted in the machining steps, an integrated value of areas of parts added or deleted in machining steps performed to the present, and a restoration flag.

The restoration flag is a flag for determining whether a part, a section, or the like deleted by the simplification processing is restored. When a designated element set as a restoration target is deleted, a value of the restoration flag only has to be set to true. The designated elements only have to be acquired from the acquirer. A restoration target designated element may be a part or all of the designated elements designated in the omission target explained above.

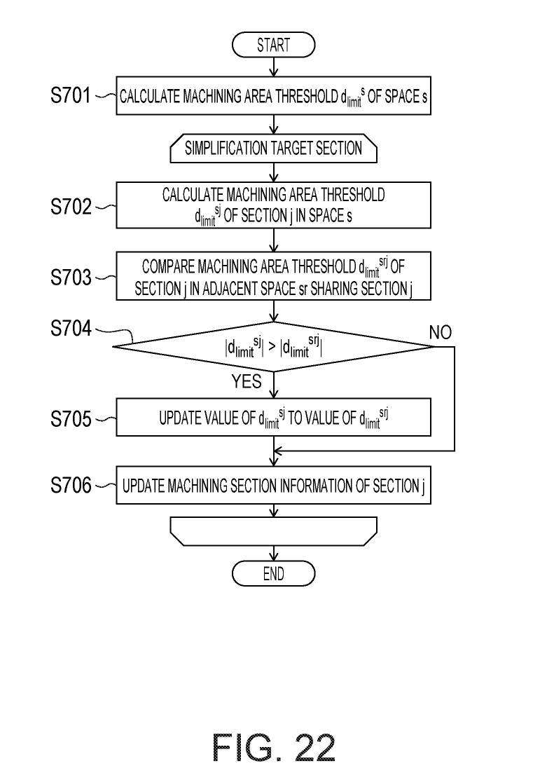

The simplification-section setter 3413 sets a simplified area threshold with respect to the respective calculated simplification sections. FIG. 22 is a flowchart for calculating the simplified area threshold. First, the simplification-section setter 3413 calculates a simplified area threshold dₗᵢₘᵢₜ^{s} of an entire space of the processing target (S701). The simplified area threshold dₗᵢₘᵢₜ^{s} is calculated as a product of an area of a target space S and a machining ratio.

The machining ratio is a ratio of an area of an added or deleted portion to an original area of an uneven portion set as a simplification target. A value of the machining ratio may be optionally decided.

The simplification-section setter 3413 calculates simplified area thresholds of sections with respect to the respective simplification sections (S702). When a simplified area threshold of a certain section j is represented as dₗᵢₘᵢₜ^{sj}, dₗᵢₘᵢₜ^{sj} is calculated by multiplying dₗᵢₘᵢₜ^{s} with a ratio of the length of the section j to an outer peripheral length of a machining target space.

Subsequently, the simplification-section setter 3413 compares a simplified area threshold dₗᵢₘᵢₜ^{srj} of the section j in an adjacent space sr, which shares the section j, and dₗᵢₘᵢₜ^{sj} in absolute values (S703). When the absolute value of dₗᵢₘᵢₜ^{sj} is larger (YES in S704), the simplification-section setter 3413 replaces a value of dₗᵢₘᵢₜ^{sj} with dₗᵢₘᵢₜ^{srj}. Otherwise (NO in S704), the simplification-section setter 3413 keeps the value of dₗᵢₘᵢₜ^{sj}. Consequently, it is possible to prevent a situation in which simplified area thresholds of the section j are different in the spaces including the section j. Incidentally, when dₗᵢₘᵢₜ^{srj} is not calculated yet, a value of dₗᵢₘᵢₜ^{Srj} may be set to an extremely large value and compared or the comparison may be omitted. The simplification-section setter 3413 updates a machining area threshold of machining section information of the simplification section (S706) and shifts to processing of the next section. When the processing ends in all the simplification sections, this flow ends. Incidentally, the simplified area thresholds are compared in the absolute values. However, an allowable range of a negative value to a positive value with respect to an increase or decrease amount of an area may be decided.

Incidentally, the machining section information includes, for each machining step, information concerning a simplification section at the time of the machining step. Therefore, by referring to the machining section information, it is possible to refer to not only a state of the simplification section after the last machining processing but also states in machining steps.

When a designated element that should be simplified is designated, the simplification-section setter 3413 may set, as a simplification section, a part or all of a shape of a surface (a side) related to the designated element.

The shape simplifier 3414 performs element simplification or linearization on a target machining surface. Either one of the element simplification and the linearization may be performed or both of the element simplification and the linearization may be performed. It may be decided in advance whether either one of these kinds of processing is performed or both of these kinds of processing is performed. Alternatively, a determination standard may be decided. The determination standard may be, for example, a type of a designated element or an area of a simplification target.

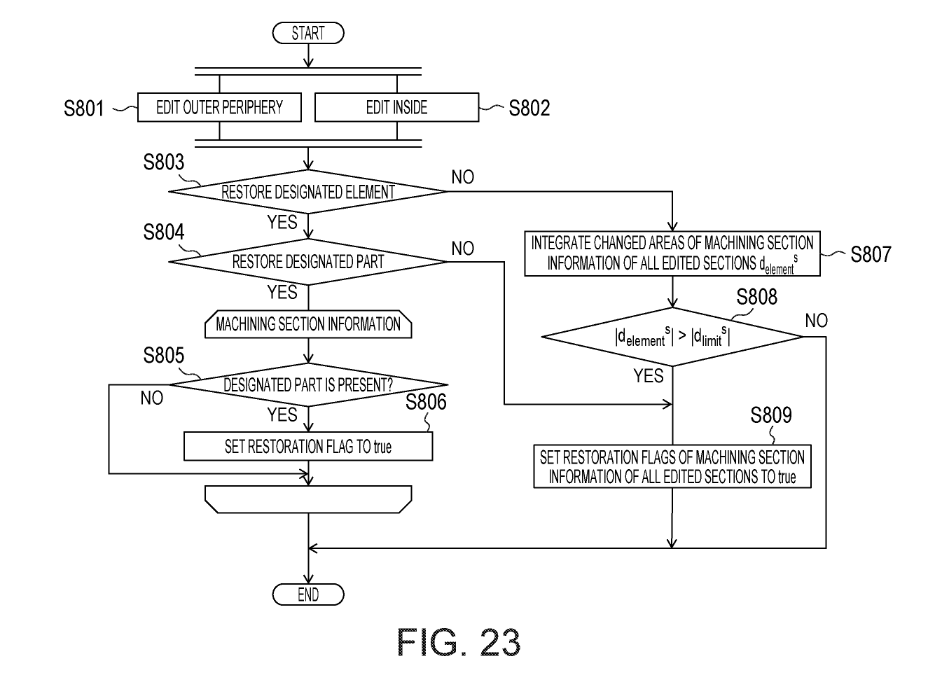

Details of the element simplification are explained now. FIG. 23 is a flowchart of element simplification processing. The shape simplifier 3414 performs machining of an outer periphery (S801) or machining of an inside (S802) or performs both of these kinds of machining. The machining of the outer periphery and the machining of the inside are explained below. After one or both of the kinds of processing are performed, processing is different according to whether a designated element deleted by these kinds of processing is restored later or not.

When the designated element is restored later (YES in S803), the shape simplifier 3414 confirms whether or not the designated element is restored in units of designated parts. When the designated element is restored in units of designated parts (YES in S804), the shape simplifier 3414 confirms whether a designated part to be restored for each kind of machining section information is included in the machining section information. When the designated part is included in the machining section information (YES in S805), the shape simplifier 3414 sets a restoration flag of the part to true (S806). Consequently, it is possible to restore only a designated specific part. When the processing is finished for all kinds of machining section information, the shape simplifier 3414 ends the processing.

When the designated element is not restored later (NO in S803), the shape simplifier 3414 integrates changed areas of machining section information of all edited sections to calculate dₑₗₑₘₑₙₜ^{s} (S807). When the absolute value of d calculated dₑₗₑₘₑₙₜ^{s} exceeds an upper limit value (YES in S808), since it is necessary to restore the designated element, the shape simplifier 3414 sets restoration flags of the machining section information of all the edited sections to true (S809) and ends the processing. Consequently, all parts of the designated element are restored. When the absolute value of calculated dₑₗₑₘₑₙₜ^{s} does not exceed the upper limit value (YES in S808), since it is unnecessary to restore the designated element, the processing ends.

When the designated element is restored later but is not restored in units of designated parts (NO in S804), that is, when all the parts of the designated element are restored, the shape simplifier 3414 sets the restoration flags of the machining section information of all the edited sections to true (S809) and ends the processing. Consequently, it is possible to restore all the parts of the designated elements. The flowchart of the element simplification processing is as explained above.

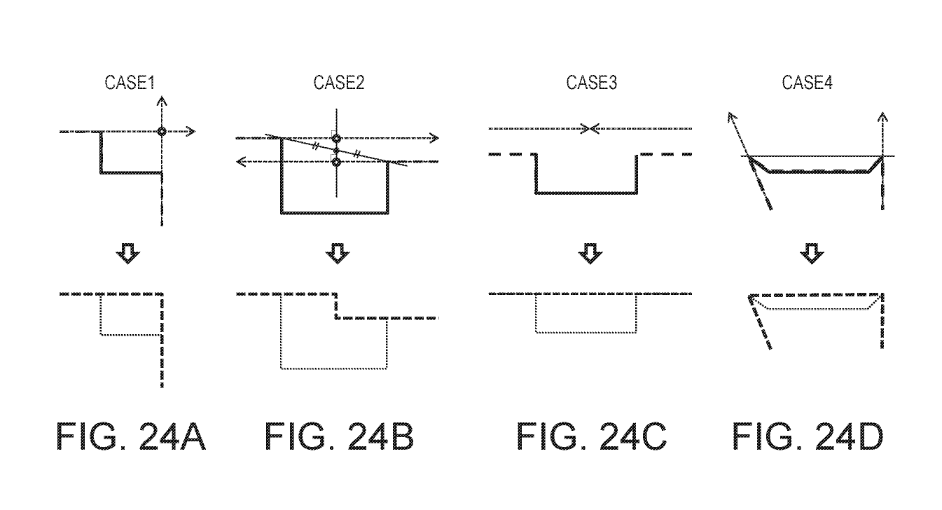

Details of the machining of the outer periphery are explained. The machining of the outer periphery is simplifying a surface concerning a designated element present on the outer circumference. A method of the simplification only has to be decided in advance according to the shape of a surface that should be simplified. FIGS. 24A to 24D are diagrams for explaining simplification of a concave section in element simplification. Four patterns of cases 1 to 4 are shown. Incidentally, the patterns are examples. The simplification is not limited to the patterns.

The case 1 shown in FIG. 24A is a pattern for extending two sides (dotted lines), which are connected to a side (a solid line) of a designated element that should be omitted, to an intersection of the two sides to thereby simplify the concave section. The case 2 shown in FIG. 24B is a pattern for, when the two sides are parallel, simplifying the concave section with perpendiculars of the two sides, which are at an equal distance from contact points of the side of the designated element that should be omitted and the two sides, and extended lines of the two sides. The case 3 shown in FIG. 24C is a pattern for, when one of the two sides is extended and the extended side overlaps the remaining one side, simplifying the concave section with the extended lines of the two sides. The case 4 shown in FIG. 24D is a pattern for, when the two sides are not parallel but the extended lines of the two sides do not cross, simplifying the concave section with lines connecting the side of the designated element that should be omitted and the contact points of the two sides.

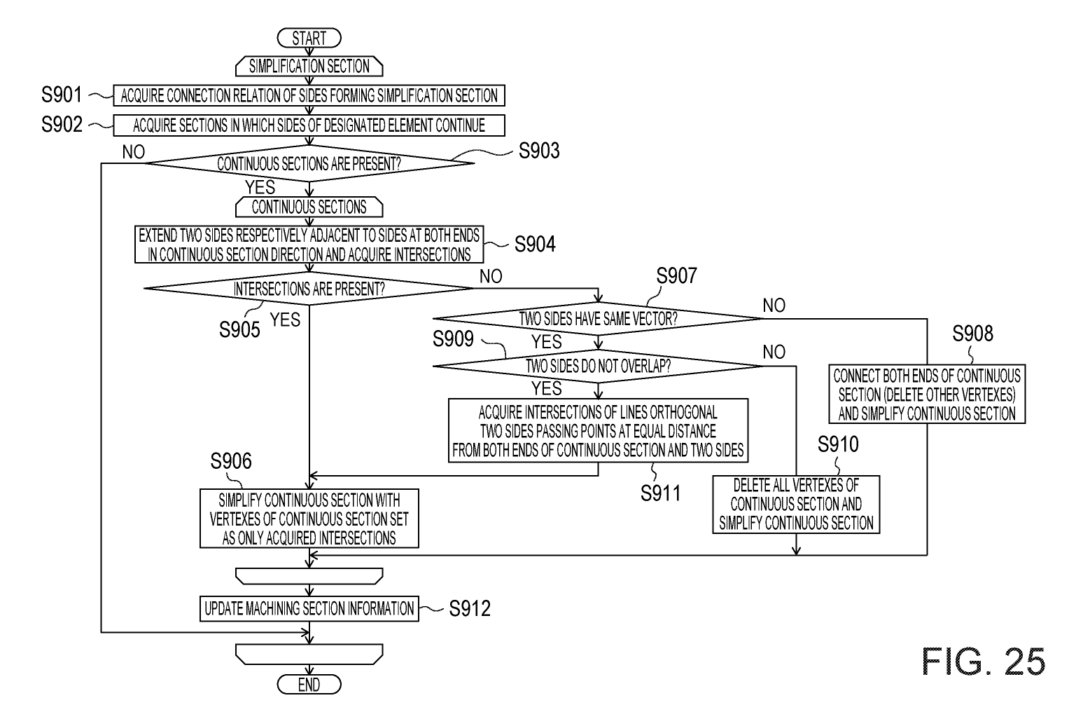

FIG. 25 is a flowchart of the machining processing of the outer periphery. The shape simplifier 3414 acquires a connection relation of sides on which the simplification section is formed (S901). The shape simplifier 3414 acquires sections in which sides of the designated element continue (S902). When continuous sections cannot be acquired (NO in S903), the shape simplifier 3414 shifts to the next simplification section. When the continuous sections can be acquired (YES in S903), the shape simplifier 3414 performs the processing on the respective continuous sections.

First, the shape simplifier 3414 extends the two sides adjacent to respective sides at both ends in a continuous section direction and acquires intersections of the two sides (S904). When the intersections can be acquired (YES in S905), the shape simplifier 3414 simplifies the continuous section with vertexes of the continuous section set as only the acquired intersections (S906). The simplification corresponds to the case 1 shown in FIG. 11.

When the intersections cannot be acquired (NO in S905), the shape simplifier 3414 confirms whether vectors of both the sides are the same. When the vectors are not the same (NO in S907), the shape simplifier 3414 connects both the ends of the continuous section, deletes other vertexes, and simplifies the continuous section (S908). The simplification corresponds to the case 4 shown in FIG. 11.

When the vectors of both the sides are the same (YES in S907), the shape simplifier 3414 confirms whether or not the two sides overlap. When the two sides overlap (NO in S909), the shape simplifier 3414 deletes all the vertexes of the continuous section and simplifies the continuous section (S910). The simplification corresponds to the case 3 shown in FIG. 11. When the two sides do not overlap (YES in S909), the shape simplifier 3414 acquires intersections of lines, which pass points at an equal distance from the continuous section both ends and are orthogonal to the two sides, and the two sides and simplifies the continuous section with vertexes of the continuous section set to only the acquired intersections (S911). The simplification corresponds to the case 2 shown in FIG. 11. Consequently, it is possible to simplify the continuous section according to any one of the four methods.

The shape simplifier 3414 performs the processing of the simplification in all the continuous sections. After the processing for all the continuous sections is completed, the shape simplifier 3414 updates the machining section information of the simplification section (S912) and shifts to processing for the next simplification section. Incidentally, the update of the machining section information means adding information concerning a result of the machining in the machining step performed by the shape simplifier 3414 rather than overwriting the machining section information. Therefore, the machining section information includes information before and after the machining step. If the processing is finished for all the simplification sections, this flow ends.

Incidentally, a target of the continuous section to be simplified may be limited. For example, an end-to-end distance of the continuous section is set as a short-circuit distance and an upper limit value of the short-circuit distance is decided. A continuous section equal to or smaller than the upper limit value of the short-circuit distance may be set as a machining target. The upper limit value of the short-circuit distance may be optionally decided. The upper limit value of the short-circuit distance only has to be decided on the basis of, for example, a load of the processing of the simulator 14.

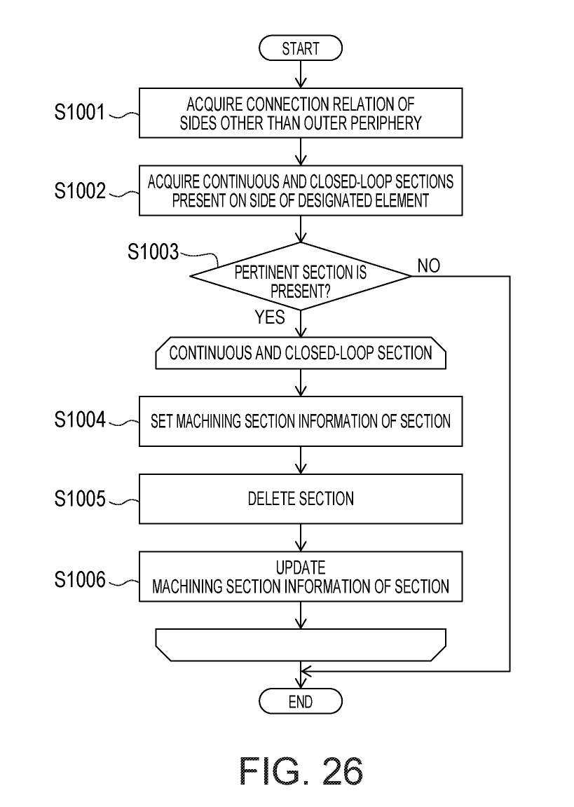

Details of the machining of the inside are explained now. FIG. 26 is a flowchart of machining processing of the inside. The simplification-section setter 3413 acquires a connection relation of sides other than the outer periphery (S1001) and searches for continuous and closed-loop sections present on a side of a designated element (S1002) on the basis of the acquired connection relation. When a relevant section is absent (NO in S1003), the processing ends. When a relevant section is present (YES in S1003), the simplification-section setter 3413 sets the section as a simplification section and sets machining section information (S1004). The shape simplifier 3414 deletes the section (S1005). The shape simplifier 3414 updates machining section information of the deleted simplification section (S1006). When other continuous and closed-loop sections are present, the processing is applied to the other sections. When the processing for all the continuous and closed-loop sections is completed, this flow ends. Incidentally, the processing by the simplification-section setter 3413 and the processing by the shape simplifier 3414 may be divided.

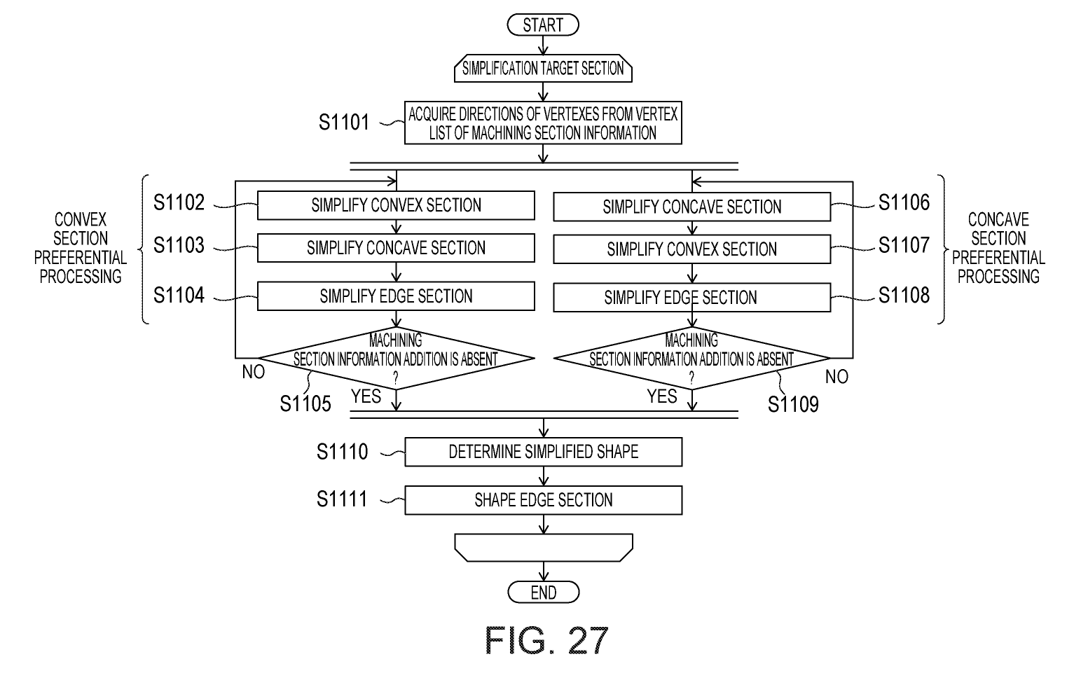

Details of the linearization are explained now. FIG. 27 is a flowchart of the linearization processing. The flow is performed on respective simplification sections.

The shape simplifier 3414 acquires the directions of vertexes from a list of vertex IDs of machining section information (S1101). The direction of a vertex means, when the simplification-section setter 3413 traces the outer periphery clockwise from a section end set as a base point and sets simplification sections, a turning direction at the vertex is clockwise or counterclockwise. Details are explained below.

Subsequently, the shape simplifier 3414 performs convex section preferential processing and concave section preferential processing. The convex section preferential processing is to perform processing in the order of simplification of a convex section (S1102), simplification of a concave section (S1103), and simplification of an edge section (S1104). The concave section preferential processing is to perform processing in the order of simplification of a concave section (S1106), simplification of a convex section (S1107), and simplification of an edge section (S1108). The convex section, the concave section, and the edge section are explained below. Simplification methods of the respective kinds of processing are the same. However, processing results are different depending on which of the simplification of the convex section and the simplification of the concave section is performed first. Therefore, the shape simplifier 3414 performs both of the convex section preferential processing and the concave section preferential processing. The convex section preferential processing and the processing of simplification of the concave section may be performed in parallel or may be performed separately. Whichever of the convex section preferential processing and the processing of simplification of the concave section may be performed first.

After the convex section preferential processing and the concave section preferential processing, the shape simplifier 3414 confirms whether information to be added to the machining section information is present (S1105 and S1109). When information to be added to the machining section information is present (NO in S1105 and NO in S1109), it is likely that a portion that should be further linearized remains. Therefore, the shape simplifier 3414 returns to the convex section preferential processing and the concave section preferential processing (S1102 and S1106).

When both of the convex section preferential processing and the concave section preferential processing are completed, the shape simplifier 3414 determines a simplified shape (S1110). The determination of a simplified shape is to compare machining results by the convex section preferential processing and the concave section preferential processing and determine a more suitable one of the machining results as a simplified shape. The machining-degree evaluator 3415 performs the determination of a simplified shape. Details are explained in explanation of the machining-degree evaluator 3415.

After the simplified shape is determined, the shape simplifier 3414 performs shaping of an edge section (S1111). The shaping of the edge section is to change a side of an edge section not parallel to an X axis or a Y axis of direction axes to a line parallel to the X axis or the Y axis. When shaping processing of the edge section is completed, the shape simplifier 3414 shifts to processing of the next simplification section. When the shape simplifier 3414 repeats this and finishes the processing for all the simplification sections, the linearization processing ends.

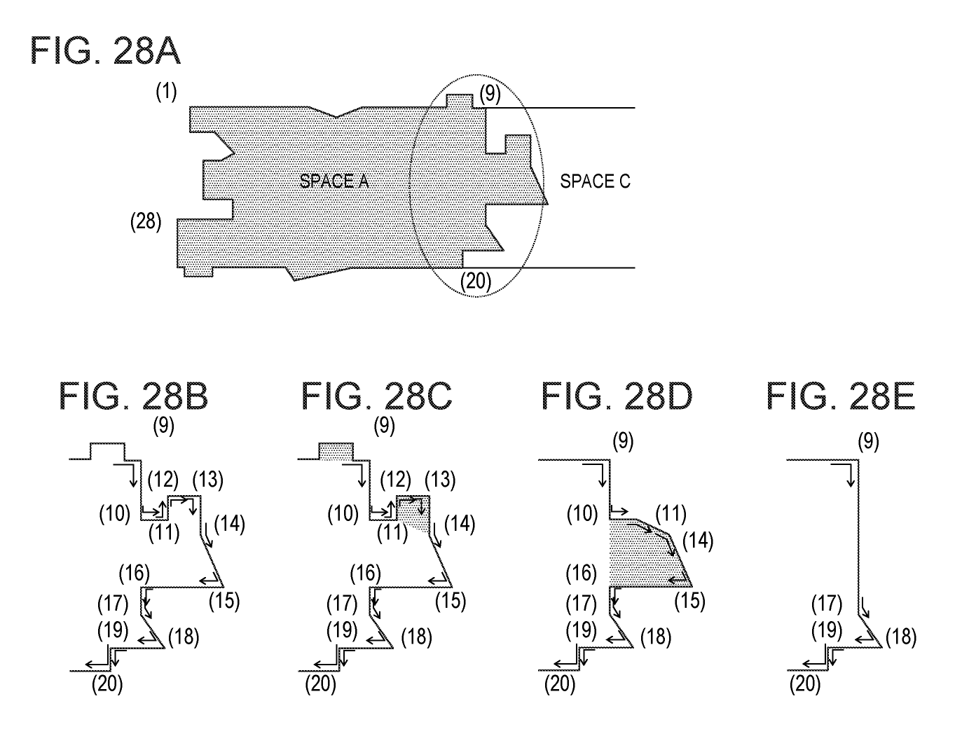

Simplification of a convex section and a concave section is explained now. FIGS. 28A to 28E are diagrams for explaining the simplification of the convex section in linearization. As shown in FIGS. 28 A to 28E, a simplification section adjacent to the space A and the space C and having a vertex (9) and a vertex (20) as section ends is simplified.

The convex section is defined as, when a start end to a terminal end of the simplification section is traced, in vertexes present on the simplification section, a portion where two or more vertexes turning to a clockwise (CW) direction continue, the portion being sandwiched by vertexes turning to a counterclockwise (CCW) direction. As shown in FIG. 28B, vertexes (10) to (19) are present on the simplification section excluding section ends. In the respective vertexes, arrows of directions turning the vertexes in tracing a start end (9) to a terminal end (20) of the simplification section are shown. The direction of the arrow of the vertex (11) is CCW. The directions of the arrows of the vertexes (12) and (13) are CW. The direction of the arrow of the vertex (14) is CCW. Therefore, the vertexes (12) and (13) turning to the direction CW continue and the vertexes (12) and (13) are sandwiched by the vertexes (11) and (14) turning to the direction of CW. Therefore, according to the definition of the convex section, a portion from the vertex (11) to the vertex (14) (a hatched portion in FIG. 28C) is a convex section. In this way, the shape simplifier 3414 recognizes the convex section on the simplification section and performs the simplification processing.

The simplification is to generate a line connecting a start end and a terminal end of a convex section and deleting vertexes present between the start end and the terminal end. The start end of the convex section is a vertex closest to a start end of the simplification section. The start end of the convex section is a vertex closest to a terminal end of the simplification section. In the example explained above, the vertexes (11) and (14) are connected and the vertexes (12) and (13) are deleted. Consequently, a shape shown in FIG. 28D is obtained. After the simplification, the shape simplifier 3414 confirms again whether a convex section is present. Then, it is possible to recognize that a portion from the vertex (10) to the vertex (16) is a new convex section. As in the above explanation, the start end (10) to the terminal end (16) of the concave section are connected by a line and the vertexes (11), (14), and (15) are deleted. Consequently, a shape shown in FIG. 28E is obtained. The shape is not a convex section because the shape does not meet the definition of the convex section, although the vertex 18 projects. Since a convex section is absent, the processing of simplification of the convex section ends. Incidentally, a projecting portion like the vertex 18 or, conversely, a buried portion, which is a shape cutting into a space inside, is referred to as edge section.

After the machining, the shape simplifier 3414 updates the machining section information of the simplification section. When the convex section is simplified, the shape simplifier 3414 calculates an area of the simplified convex section and a total area d_{convex}^{sj} of the convex section simplified by the simplification processing performed to that point.

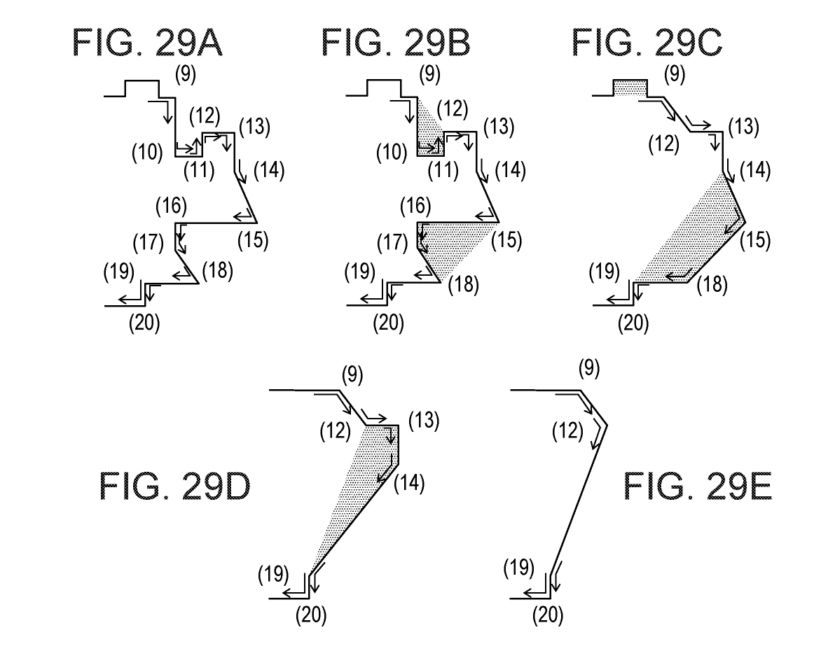

FIGS. 29A to 29E are diagrams for explaining simplification of a concave section in linearization. FIG. 29A is the same as FIG. 28B. The concave section is defined as, when a start end to a terminal end of the simplification section is traced, in vertexes present on the simplification section, a portion where two or more vertexes turning to the CCW direction continue, the portion being sandwiched by vertexes turning to the CW direction. Therefore, gray portions shown in FIGS. 29B, C, and D are concave sections. The simplification of the concave section is the same as the simplification of the convex section except that a target is the concave section. The shape simplifier 3414 recognizes a concave section on the simplification section and repeats the simplification processing to obtain a simplification result shown in FIG. 29E. As it is seen from FIG. 28E and FIG. 29E, the simplification result of the convex section and the simplification result of the concave section are different. Therefore, as explained above, a processing result is different depending on which of the simplification of the convex section and the simplification of the concave section is performed first.

Simplification of an edge section is explained now. Even if the simplification of the convex section or the concave section is performed as shown in FIG. 28E, an edge portion, which is a projecting or buried portion sometimes remains. In order to cope with such a case, the shape simplifier 3414 simplifies the edge section according to a method decided in advance.

Incidentally, it is assumed that the edge portions are two edges of a concave edge and a convex edge. The concave edge is defined as, when a start end to a terminal end of the simplification section is traced, in vertexes present on the simplification section, a portion where vertexes turning to the CCW direction is sandwiched by vertexes turning to the CW direction. The convex edge is defined as, in vertexes present on the simplification section, a portion where vertexes turning to the CW direction is sandwiched by vertexes turning to the CCW direction.

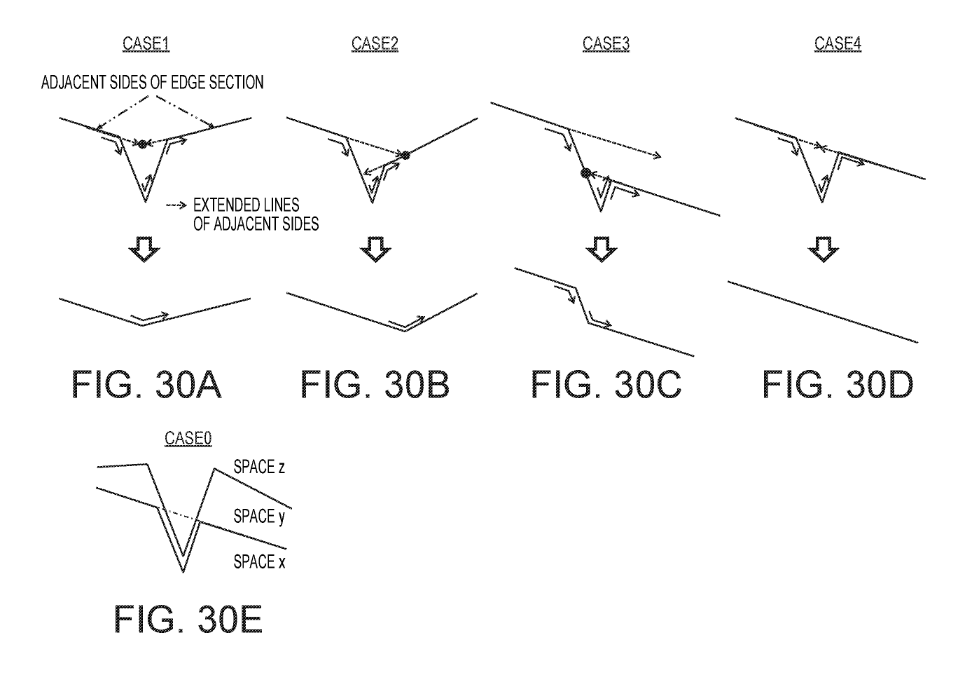

A method of the simplification only has to be decided in advance according to the shape of a portion that should be simplified. FIGS. 30A to 30E are diagrams for explaining simplification of a concave edge. Four patterns of cases 1 to 4 are shown. Incidentally, the patterns are examples. The simplification is not limited to the patterns. Incidentally, in FIGS. 30A to 30E, the concave edge is shown. However, the patterns are the same in a convex edge.

The case 1 shown in FIG. 30A is a pattern for, when an intersection at the time when two sides adjacent to an edge section are extended is absent on lines of the two sides, extending the two sides to the intersection to thereby simplify the edge section. The case 2 shown in FIG. 30B is a pattern for, when an intersection at the time when two sides adjacent to an edge section are extended is present on a line of either one of the two sides, extending one of the two sides to the intersection to thereby simplify the edge section. The case 3 shown in FIG. 30C is a pattern for, if an intersection is absent even if two sides adjacent to an edge section are extended, when an extended line of one of the two sides is in contact with a side of the edge section, simplifying the edge section with the extended line. The case 4 shown in FIG. 30D is a pattern for, when one of two sides adjacent to an edge section is extended, if the one side overlaps the other side, simplifying the edge section with an extended line of the one side.

In the simplification of the edge section, consistency with other spaces is also taken into account. For example, a simplified shape could be inappropriate because of a relation with the other spaces. A case 0 in FIG. 30E is an example of the case in which a simplified shape is inappropriate. The case 0 is a pattern obtained by simplifying an edge section of an adjacent side of a space X and a space Y is simplified by the case 4. However, when the edge section is simplified in this way, an adjacent side of the space Y and a space Z is divided and consistency cannot be secured. In this way, the simplified edge section is sometimes restored taking into account consistency with the adjacent side.

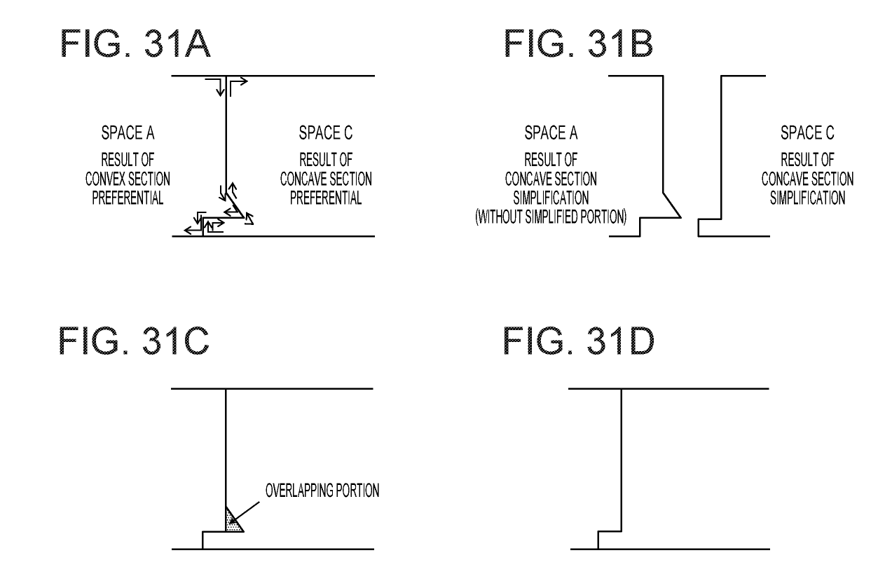

When there are adjacent spaces, a simplification processing result of one space and a simplification processing result of the other space do not always coincide with each other. Therefore, both-edge simplification is performed. FIGS. 31A to 31D are diagram for explaining the both-edge simplification. FIG. 31A shows a result obtained by performing simplification on the space A in the convex section preferential processing and a result obtained by performing simplification on the space C in the concave section preferential processing. An edge portion is present on an adjacent side of the space A and the space C. FIG. 31B shows a result obtained by performing concave edge simplification processing on the space A and the space C. For the concave edge simplification processing, a projecting portion on the space A side is not deleted. On the other hand, a buried portion on the space C side is deleted. When the space A and the space C are joined, an overlapping portion is formed as shown in FIG. 31C. In both both-edge simplification processing, the overlapping portion is deleted. FIG. 31D shows a state after the both-edge simplification processing. Consequently, a shape in which consistency of the spaces is secured is obtained while being simplified.

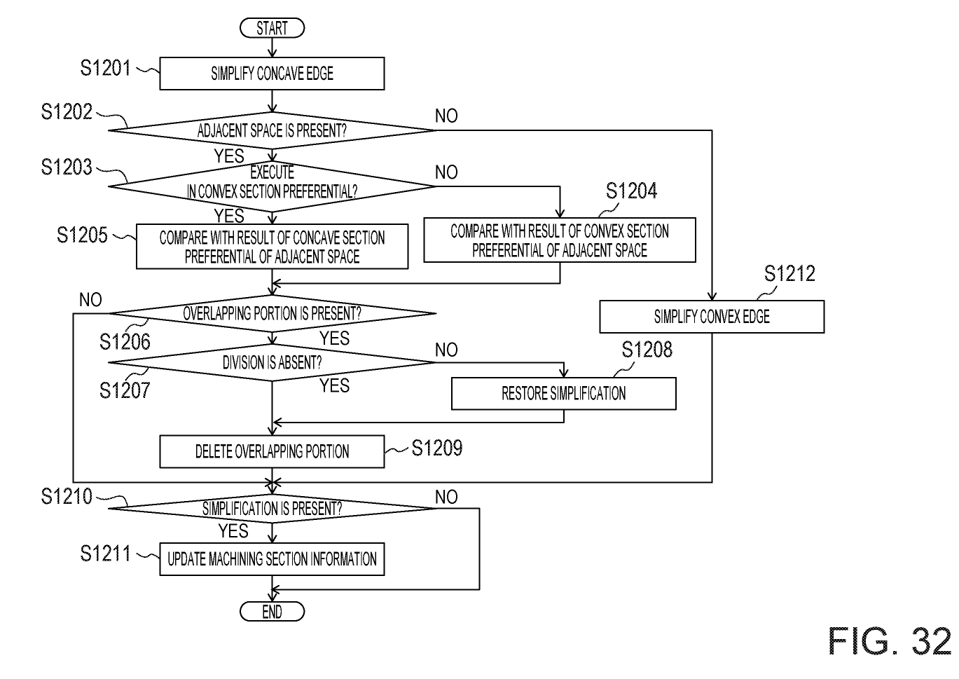

FIG. 32 is a flowchart of the simplification of an edge section. First, the shape simplifier 3414 performs simplification of a concave edge (S1201). The shape simplifier 3414 confirms presence or absence of an adjacent space. When an adjacent space is present (YES in S1202), the shape simplifier 3414 performs both-edge simplification with the adjacent space is performed. In the both-edge simplification, processing is different depending on which of simplification of a convex section and simplification of a concave section performed before the simplification of the edge section is performed first. When the concave section is simplified first (NO in S1203), the shape simplifier 3414 compares the adjacent space with a result obtained by simplifying the convex section first (S1204). Conversely, when the convex section is simplified first (YES in S1203), the shape simplifier 3414 compares the adjacent space with a result obtained by simplifying the concave section first (S1205).

As a result of the comparison with the adjacent space (S1204 and S1205), when an overlapping portion is absent (NO in S1206), only when a portion simplified by the processing of this time is present (YES in S1210), the shape simplifier 3414 updates the machining section information (S1211).

As a result of the comparison with the adjacent space (S1204 and S1205), when an overlapping portion is present (YES in S1206), the shape simplifier 3414 confirms whether a simplification result that divides the adjacent space is present. When a simplification result that divides the adjacent space is present (NO in S1207), the shape simplifier 3414 restores the simplification of the edge. When a portion that divides the adjacent space is absent (YES in S1207) or after restoring the simplification (S1208), the shape simplifier 3414 deletes the overlapping portion of the adjacent spaces (S1209). When there is a portion simplified by the processing of this time (YES in S1210), the shape simplifier 3414 updates the machining section information (S1211).

When an adjacent space is absent (NO in S1202), the shape simplifier 3414 performs simplification of a convex edge (S1212). When an adjacent space is present, since the convex edge is removed by adjustment with the adjacent space, it is unnecessary to perform simplification of the convex edge. However, when an adjacent space is absent, it is necessary to perform simplification of the convex edge. After simplification processing of the convex edge (S1212), when a simplified concave edge or convex edge is present (YES in S1210), the shape simplifier 3414 updates the machining section information of the simplification section (S1211). A flow of the simplification of the edge section is as explained above.

Simplification of a concave edge and simplification of a convex edge are explained now. An only difference between the simplification of a concave edge and the simplification of a convex edge is whether a target of the simplification is a convex section or a concave section. Therefore, the simplification of a concave edge is explained. Explanation of the convex section simplification is omitted.

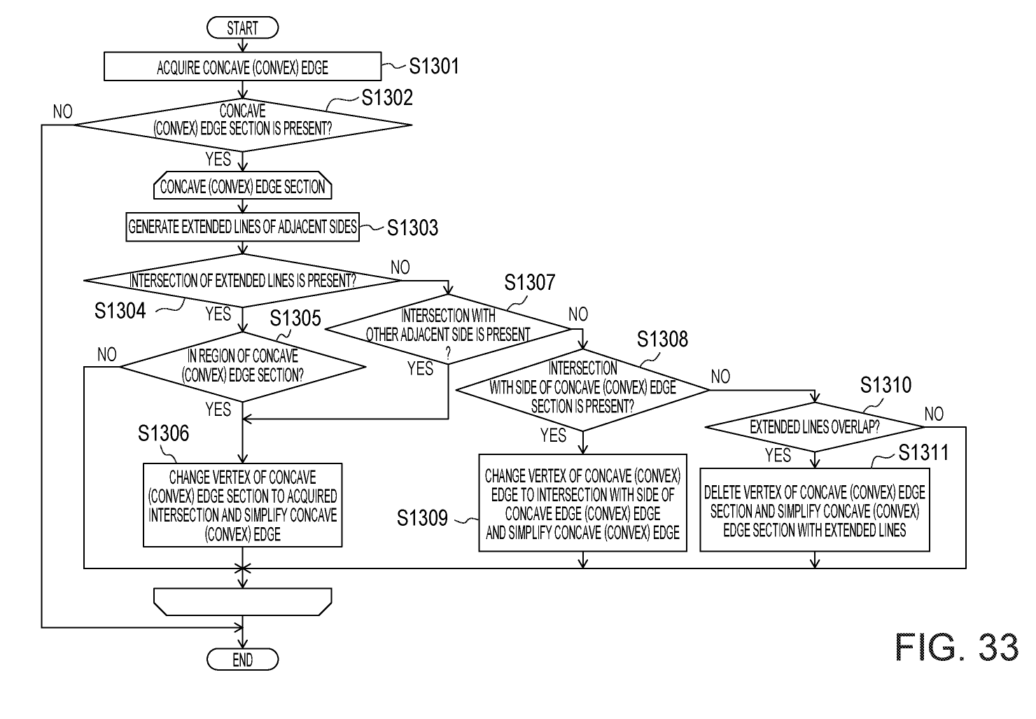

FIG. 33 is a flowchart of the simplification of a concave edge. First, the shape simplifier 3414 acquires a concave edge (S1301). When a concave edge cannot be acquired (NO in S1302), the flow ends. When concave edges can be acquired (YES in S1302), the shape simplifier 3414 performs the processing on the respective acquired concave edges.

First, the shape simplifier 3414 extends two sides adjacent to respective sides at both ends of the concave edge in a continuous section direction and generates extended lines (S1303). When an intersection of the two extended lines is present (YES in S1304), the shape simplifier 3414 checks whether the intersection is in a concave edge region. When the intersection is not in the concave edge region (NO in S1305), the shape simplifier 3414 shifts to processing of the next concave edge. When the intersection is in the concave edge region (YES in S1305), the shape simplifier 3414 changes a vertex of the concave edge to the acquired intersection and simplifies the concave edge (S1306). The shape simplifier 3414 shifts to processing of the next concave edge. The simplification corresponds to the case 1 shown in FIGS. 30A to 30E.

When an intersection of the two extended lines is absent (NO in S1304), the shape simplifier 3414 confirms whether an intersection with the other adjacent side is present. When an intersection with the other adjacent side is present (YES in S1307), the shape simplifier 3414 changes the vertex of the concave edge to the acquired intersection and simplifies the concave edge (S1306). The shape simplifier 3414 shifts to processing of the next concave edge. The simplification corresponds to the case 2 shown in FIGS. 30A to 30E. When an intersection with the other adjacent side is absent (NO in S1307), the shape simplifier 3414 confirms that an intersection with a side of the concave edge is present.

When an intersection with the side of the concave edge is present (YES in S1308), the shape simplifier 3414 changes the vertex of the concave edge to the intersection with the side of the concave edge, simplifies the concave edge (S1311), and shifts to processing of the next concave edge. The simplification corresponds to the case 3 shown in FIGS. 30A to 30E. When an intersection with the side of the concave edge is absent, the shape simplifier 3414 confirms whether the extended lines generated earlier overlap each other (S1310). When the extended lines overlap (YES in S1310), the shape simplifier 3414 deletes the vertex of the concave edge, simplifies the concave edge with the extended lines (S1311), and shifts to processing of the next concave edge. The simplification corresponds to the case 4 shown in FIGS. 30A to 30E. When the extended lines do not overlap (NO in S1310), the shape simplifier 3414 shifts to processing of the next concave edge without simplifying the edge.

When the processing for all the acquired concave edges is completed, this flow ends.

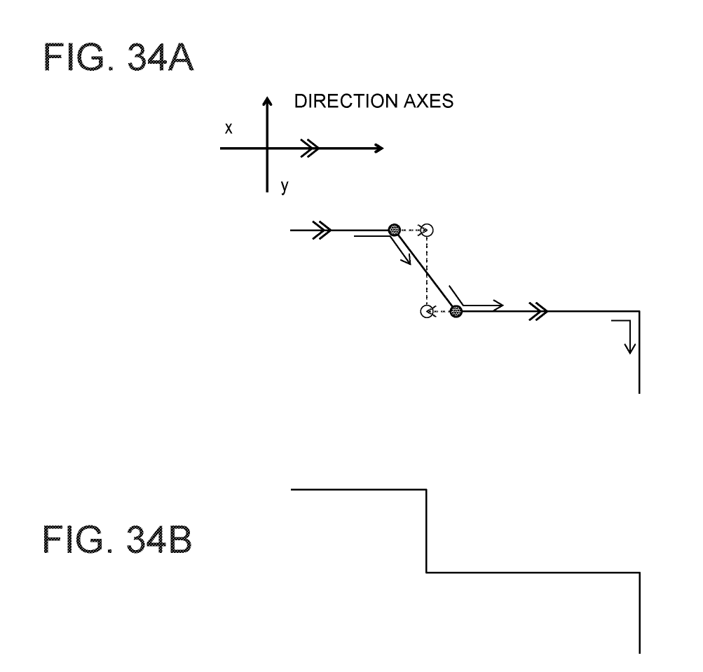

Shaping of an edge section is explained now. The shape simplifier 3414 changes a side of an edge section not parallel to the X axis or the Y axis of the direction axes to a line parallel to the X axis or the Y axis. FIGS. 34A and 34B are diagrams for explaining the shaping of an edge section. FIG. 34A is an edge section before shaping.

Black circles are two of three vertexes of the edge section. A side between the two vertexes is not parallel to both of the X axis and the Y axis of the direction axes. Therefore, the shape simplifier 3414 performs shaping processing on the side. However, the shape simplifier 3414 performs the shaping processing only when two sides connected to a side of a target edge section are parallel to the direction axes. Incidentally, in the case of this method, since a simplified area does not fluctuate, the method can also be performed after a simplified shape is determined.

When both of the two sides connected to the side of the target edge section are parallel to the X axis or the Y axis of the direction axes, the shape simplifier 3414 generate a perpendicular to extended lines of the two sides passing a midpoint of the side of the target edge section. The shape simplifier 3414 acquires intersections (white circles shown in FIG. 34A) where the perpendicular crosses the extended lines of the two sides. The shape simplifier 3414 replaces the side of the target edge section with the acquired line connecting the two intersections and the extended lines of the two sides extended to the intersections. FIG. 34B is the edge section after the shaping. Consequently, it is possible to reduce shapes of machining surfaces not parallel to the X axis or the Y axis of the direction axes.

The machining-degree evaluator 3415 determines whether a result of simplification machining is within a limitation range of shape machining. Specifically, in the linearization by the shape simplifier 3414, the shape simplifier 3414 compares the calculated machining result by the convex section preferential processing and the machining result by the concave section preferential processing and determines a simplified shape. However, it is likely that the machining result by the convex section preferential processing and the machining result by the concave section preferential processing exceed the simplified area threshold calculated by the simplification-section setter 3413. Therefore, the machining-degree evaluator 3415 confirms whether the machining results exceed the simplified area threshold. When the machining results exceed the simplified area threshold, the machining-degree evaluator 3415 traces back the machining steps one by one and confirms whether a result of the machining processing in the traced-back step exceeds the simplified area threshold. Consequently, it is possible to recognize a nearest machining step in which a result of the machining processing is smaller than the simplified area threshold and a machining result in the machining step. The machining-degree evaluator 3415 compares the machining result by the convex section preferential processing that is smaller than the simplified area threshold and the machining result by the concave section preferential processing that is smaller than the simplified area threshold and determines a simplified shape.

The machining-degree evaluator 3415 calculates an evaluation value for a machining result and determines a simplified shape on the basis of the evaluation value. An evaluation value may be optionally decided according to a purpose of use. For example, a method of calculating an evaluation value on the basis of a basic axis is conceivable. The machining-degree evaluator 3415 may calculate a difference (a deviation) between a direction (a vector) of a basis axis of a plane and a direction (a vector) of a simplification section and, for example, set an evaluation value to an inverse of the difference to set the evaluation value higher as the difference is smaller. When there are a plurality of basic axes, the machining-degree evaluator 3415 may calculate differences between the basic axes and the simplification section and set the evaluation value higher as a sum of the absolute values of the differences is smaller. The machining-degree evaluator 3415 may set the evaluation value higher as an area added or subtracted by simplification is smaller. The machining-degree evaluator 3415 may set the evaluation value higher as the number of vertexes present in the simplification section is smaller. A method of calculating an evaluation value may be one method or a plurality of methods may be combined. When the plurality of methods are combined, weighting may be performed for each of the methods. Weight may be optionally decided.

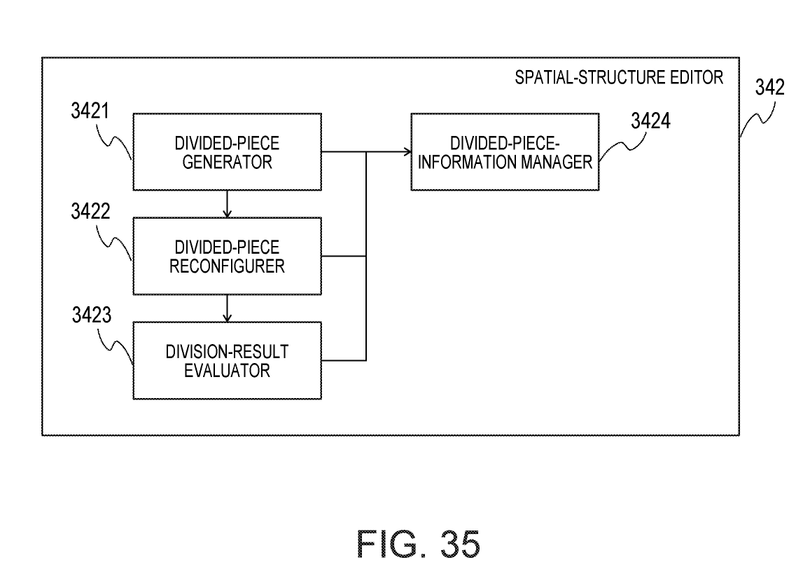

Details of the processing of the spatial-structure editor 342 are explained now. FIG. 35 is a block diagram showing an example of a schematic configuration of the spatial-structure editor 342. The spatial-structure editor 342 includes a divided-piece generator 3421, a divided-piece reconfigurer 3422, a division-result evaluator 3423, and a divided-piece-information manager 3424.

The divided-piece generator 3421 sets, as a division reference, the position of an object of a type of a designated element designated in advance and generates lines for dividing a machining surface, which is a machining target. The divided-piece generator 3421 sets, as divided pieces, regions surrounded by the division lines or regions surrounded by a contour line of the shape of the machining surface and the division lines.

Incidentally, the machining surface may be acquired from the spatial-shape editor 341. Alternatively, the spatial-structure editor 342 may include a device same as the machining-surface acquirer 3411 of the spatial-shape editor 341 and generate a machining surface.

The designated element to be set as the division reference may be an element concerning a structure of a building such as a wall or a column or may be an element concerning equipment of the building such as equipment. The division reference and the dividing method may be decided in advance or may be designated via the inputter 11 and the acquirer 12.

The divided-piece reconfigurer 3422 reconfigures divided pieces. The reconfiguration means combining a plurality of divided pieces.

The divided-piece-information manager 3424 manages a result of machining as divided piece information. The divided piece information is generated by the divided-piece generator 3421 during generation of divided pieces. It is conceivable that the divided piece information includes IDs associated with divided pieces, the number of machining steps in which the divided pieces are generated, IDs and position coordinates of vertexes included in the divided pieces, a combined piece ID list, which is a list of combined pieces obtained by combining the divided pieces, an adjacent piece ID list, which is a list of adjacent divided pieces, original space IDs, and a section ID list representing a simplified section overlapping the shapes of the divided pieces.

Incidentally, the divided piece information includes, for each of the machining steps, information concerning divided pieces during the machining step. Therefore, by referring to the divided piece information, it is possible to refer to not only a state of the divided pieces after the last machining processing but also states in the machining steps.

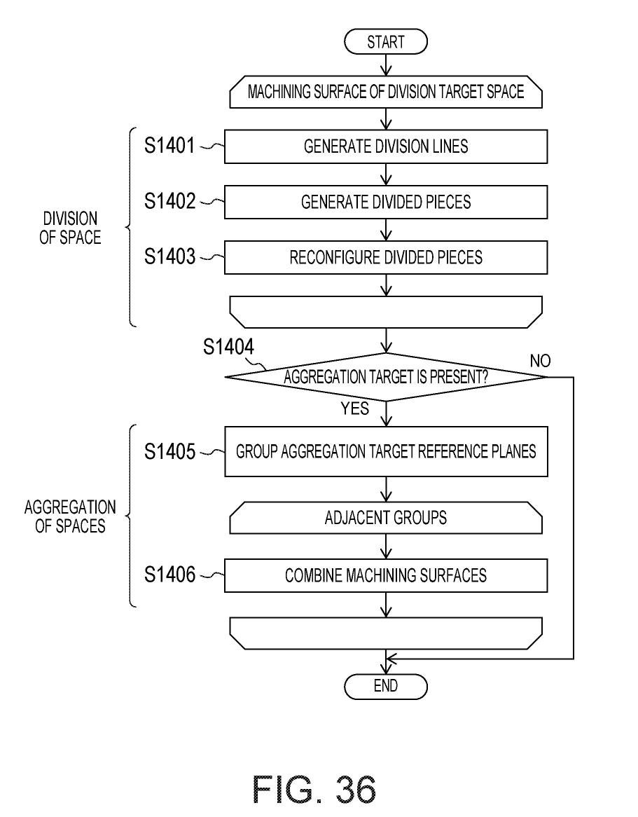

FIG. 36 is a schematic flowchart of spatial-structure machining processing. First, the spatial-structure editor 342 performs, on respective machining surfaces, which are division targets, processing concerning division of a space. The processing concerning division of a space includes three kinds of processing, that is, generation of division lines (S1401), generation of divided pieces (S1402), and reconfiguration of divided pieces (S1403). The divided-piece generator 3421 performs the generation of division lines and the generation of divided pieces. The divided-piece reconfigurer 3422 performs the reconfiguration of divided pieces.

Subsequently, the spatial-structure editor 342 performs processing concerning aggregation of spaces. The aggregation is performed targeting machining surfaces other than the division target. When aggregation targets are absent or the aggregation is not performed (NO in S1404), the aggregation processing is omitted. When aggregation targets are present (YES in S1404), first, the spatial-structure editor 342 groups machining surfaces that are the aggregation targets and adjacent to one another (S1405). The spatial-structure editor 342 combines machining surfaces with respect to the respective groups (S1406). The divided-piece reconfigurer 3422 performs these kinds of aggregation processing.

A method of generating divided pieces is explained with reference to FIGS. 14A to 14C referred to above. The divided-piece generator 3421 generates division lines that overlap the sides of the columns. In FIG. 14B, the division lines generated in this way are represented by dotted lines. The divided-piece generator 3421 generates perpendiculars passing midpoints of sides not in contact with the outer periphery of the machining surface. In FIG. 14B, the perpendiculars are represented by broken lines. Among the division lines generated in this way, the division lines not orthogonal to the outer periphery of the machining surface and the other division lines are deleted. As shown in FIG. 14C, regions surrounded by the division lines or regions surrounded by a contour line of the shape of the machining surface are divided pieces. When the divided pieces are generated, the divided-piece generator 3421 generates divided piece information. The method of generating divided lines is the same as one of the methods of acquisition of direction axes performed by the direction-axis acquirer 3412 of the spatial-shape editor 341 explained above. Incidentally, division lines may be generated by a method different from the method of acquisition of direction axes.

A method of reconfiguring divided pieces is explained with reference to FIGS. 15A to 15C referred to above. The divided-piece reconfigurer 3422 performs combination processing on the divided pieces shown in FIG. 15A. The combination processing is processing for combining (absorbing) a divided piece having a minimum area with (into) divided pieces adjacent to the divided piece in the direction of the X axis or the Y axis of basic axes. FIG. 15B shows a case in which divided pieces adjacent to one another in the X-axis direction are combined. When a divided piece is adjacent to a plurality of divided pieces, divided pieces to be combined with the divided piece may be optionally selected. However, it is assumed that the divided piece is combined with a divided piece having a larger area. The combination is repeated as long as an area of a divided piece generated anew by the combination does not exceed a threshold designated in advance. Consequently, only divided pieces having areas equal to or larger than a fixed value remain. Subsequently, the same combination processing is performed on divided pieces adjacent to one another in an axis direction different from the axis direction in the combination processing explained above. FIG. 15C shows a case in which divided pieces adjacent to one another in the Y-axis direction are combined after the divided pieces adjacent to one another in the X-axis direction are combined. It is seen that small divided pieces present in FIG. 15B disappear. In FIG. 15C, the divided pieces are further combined in the Y-axis direction to generate larger divided pieces. In this way, the divided pieces become as shown in FIG. 15D.

Incidentally, as explained concerning the determination method for the direction axes, when there are a plurality of direction axes, the combination of the divided pieces may be performed for each of the direction axes.

Incidentally, a result of combination is different depending on which of the X axis and the Y axis the combination is performed. Therefore, the divided-piece reconfigurer 3422 calculates evaluation values of combination results after performing both of the combination performed on the X axis first and the combination performed on the Y axis first. The divided-piece reconfigurer 52 adopts a combination result with a better evaluation value as a final result. A calculation method may be optionally decided. For example, when a smaller number of generated divided pieces is better, the divided-piece reconfigurer 3422 calculates an evaluation value on the basis of the number of divisions. When a uniform size of generated divided pieces is better, the divided-piece reconfigurer 3422 calculates an evaluation value on the basis of a standard deviation of areas of divided pieces. When the sizes of generated divided pieces are desirably as large as possible, the divided-piece reconfigurer 3422 calculates an evaluation value on the basis of a deviation between areas of generated divided pieces and an upper limit value of areas of divided pieces decided in advance. Incidentally, a method of calculating an evaluation value may be one method or a plurality of methods may be combined. When the plurality of methods are combined, weighting may be performed for each of the methods. Weight may be optionally decided.

The divided-piece reconfigurer 3422 updates divided piece information and machining section information concerning the divided pieces by the reconfiguration adopted as the final result. Consequently, divided pieces excluding the designated elements are generated.

As explained above, according to the second embodiment, it is possible to simplify the shape and the structure of the building model. It is possible to reduce a load of the processing of the simulator 14.

Each process in the embodiments described above can be implemented by software (program). Thus, the embodiments described above can be implemented using, for example, a general-purpose computer apparatus as basic hardware and causing a processor mounted in the computer apparatus to execute the program.

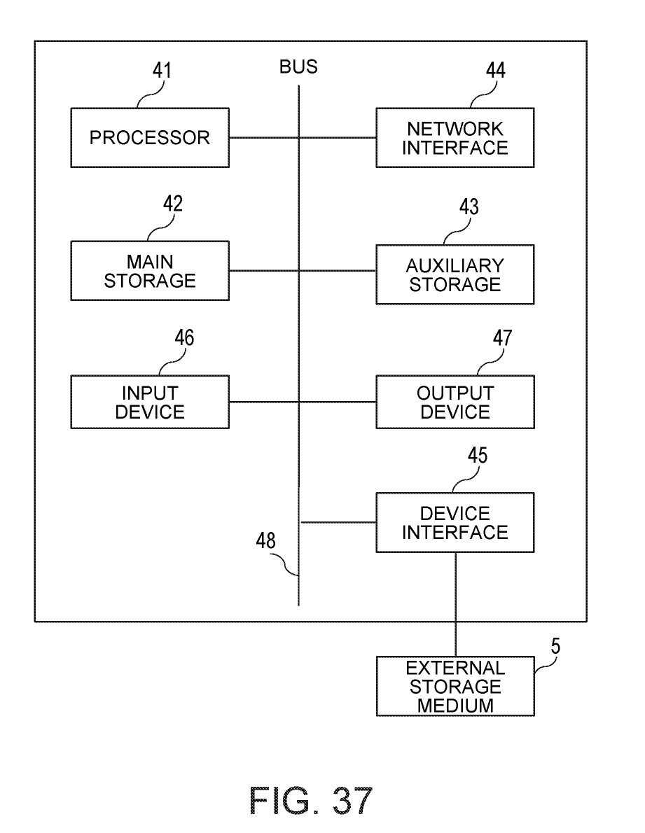

FIG. 37 is a block diagram showing an example of a hardware configuration that realizes an operation-draft-plan creation apparatus according to an embodiment of the present invention. The operation-draft-plan creation apparatus includes a processor 41, a main storage 42, an auxiliary storage 43, a network interface 44, a device interface 45, an input device 46, and an output device 47. The operation-draft-plan creation apparatus can be realized as a computer apparatus 4 in which these devices are connected via a bus 48 and the like.

The processor 41 can realize functions of the operation-draft-plan creation processor 1, the deterioration-model processor 2, and the building-model processor 3 by reading out a computer program from the auxiliary storage 43, expanding the computer program in the main storage 42, and executing the computer program.

The processor 41 is an electronic circuit including a control device and an arithmetic device of a computer. As the processor 41, for example, a general-purpose processor, a central processing unit (CPU), a microprocessor, a digital signal processor (DSP), a controller, a microcontroller, a state edit, an application-specific integrated circuit, a field programmable gate array (FPGA), a programmable logic circuit (PLD), and a combination of the foregoing can be used.

The operation-draft-plan creation apparatus in this embodiment may be realized by installing, in the computer apparatus 4, in advance, a program executed in the operation-draft-plan creation apparatus or may be realized by storing the program in a storage medium such as a CD-ROM or distributing the program via a network and installing the program in the computer apparatus 4 as appropriate.

The network interface 44 is an interface for connection to a network. As the network interface 44, a network interface conforming to an existing radio standard only has to be used. The inputter 11, the acquirer 12, and the outputter 16 may realize input and output of data with the network interface 44. Only one network interface is shown. However, a plurality of network interfaces may be mounted.

The device interface 45 is an interface for connecting to a device such as an external storage medium 5. The external storage medium 5 may be any storage medium such as a HDD, a CD-R, a CD-RW, a DVD-RAM, a DVD-R, or a SAN (Storage area network).

The respective storages may be connected to the device interface 45 as an external storage medium 5.

The main storage 42 is a memory device that temporarily stores a command executed by the processor 41, various data, and the like. The main storage 42 may be a volatile memory such as a DRAM or may be a nonvolatile memory such as a MRAM. The auxiliary storage 43 is a storage device that permanently stores computer programs, data, and the like. As the auxiliary storage 43, there are, for example, a HDD or a SSD. The respective storages may be realized as the main storage 42 and the auxiliary storage 43.

The respective devices of the operation-draft-plan creation apparatus may be configured by dedicated hardware such as a semiconductor integrated circuit mounted with the processor 41 and the like.

The input device 46 includes input devices such as a keyboard, a mouse, and a touch panel and realizes the function of the inputter 11. Operation signals by operation of the input devices from the input device 46 are output to the processor 41. The input device 46 or the output device 47 may be connected to the device interface 45 from the outside.

The output device 47 realizes the function of the outputter 16. The output device 47 may be a display such as an LCD (Liquid Crystal Display) or a CRT (Cathode Ray Tube).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An operation-draft-plan creation apparatus comprising:
an acquirer configured to acquire a deterioration model regarding performance of a similar measurement target which is a measurement target considered to be similar to an operation target, the deterioration model being calculated on the basis of a measurement value of the similar measurement target;
a simulator configured to perform a simulation concerning deterioration of performance of the operation target on the basis of the deterioration model regarding the performance of the similar measurement target and a use case example assumed for the operation target; and
an operation-draft-plan creator configured to create, on the basis of a result of the simulation, an operation draft plan indicating an implementation period of maintenance work performed on the operation target.

2. The operation-draft-plan creation apparatus according to claim 1 further comprising a deterioration-model generator configured to cyclically calculate a probability density distribution of a parameter representing a performance of the measurement target calculated at each of a plurality of times on the basis of a measurement value of the measurement target measured before the time and generate a deterioration model regarding the performance of the measurement target on the basis of a calculated plurality of the probability density distributions, wherein
the deterioration model regarding performance of the similar measurement target is acquired among the deterioration models regarding the performance of the measurement target.

3. The operation-draft-plan creation apparatus according to claim 1, further comprising:
a use-case-example extractor configured to extract a use case example of the measurement target from measurement data of the measurement target; and
a deterioration-model storage configured to store, for each of the measurement targets, a deterioration model regarding the performance of the measurement target and the use case example in association with each other, wherein
the acquirer acquires the deterioration model regarding the performance of the similar measurement target by regarding, as the similar measurement target, a measurement target having a use case example similar to the use case example assumed for the operation target.

4. The operation-draft-plan creation apparatus according to claim 1, further comprising:
a use-case-example extractor configured to extract a use case example of the measurement target from measurement data of the measurement target;
an ontology storage configured to store ontology in which a characteristic use case example of the measurement target and information concerning the measurement target are systemized; and
a deterioration-model storage configured to store, for each of the measurement targets, a deterioration model regarding the performance of the measurement target and the ontology in association with each other, wherein
the acquirer acquires the deterioration model regarding the performance of the similar measurement target and the characteristic use case example selected from a deterioration-model storage on the basis of information concerning the operation target, and
the simulator uses a characteristic use example of the similar measurement target as the use case example assumed for the operation target.

5. The operation-draft-plan creation apparatus according to claim 1, further comprising:
a building-data storage configured to store data concerning a building including a building model; and
a building-model extractor configured to extract, on the basis of data concerning a first building in which the operation target is set, a building model of a second building similar to the first building from the building-data storage, wherein
the acquirer acquires the building model of the second building as a building model of the first building,
the simulator performs the simulation on the basis of the deterioration model regarding the performance of the similar measurement target, the use case example assumed for the operation target, and the building model of the first building,
at least information concerning an attribute, a shape, or a structure of an object in the building is included in the data concerning the building stored by the building-data storage, and
the building-model extractor determines that a building including an object with which or to which at least any one of an attribute, a shape, and a structure of an object of the first building coincides or is similar is similar.

6. The operation-draft-plan creation apparatus according to claim 5, further comprising a spatial-shape editor configured to perform simplification of the building model by linearizing or simplifying a shape of an outer periphery or an inner periphery of a plane included in the building model or a portion concerning a designated element or a shape of the portion.

7. The operation-draft-plan creation apparatus according to claim 5, further comprising a spatial-structure editor configured to perform simplification of the building model by performing division of a plane included in the building model or aggregation of a plurality of planes included in the building model.

8. The operation-draft-plan creation apparatus according to claim 1, wherein
the acquirer acquires a deterioration model of a first operation target and a deterioration model of a second operation target,
the simulator performs a first simulation based on the deterioration model of the first operation target and a second simulation based on the deterioration model of the second operation target, and
the operation-draft-plan creator creates, on the basis of a result of the first simulation and a result of the second simulation, an operation draft plan in replacing the first operation target with the second operation target.

9. An operation-draft-plan creation method in which a computer executes:
acquiring a deterioration model regarding performance of a similar measurement target which is a measurement target considered to be similar to an operation target, the deterioration model being calculated on the basis of a measurement value of the similar measurement target;
performing a simulation concerning deterioration of performance of the operation target on the basis of the deterioration model regarding the performance of the similar measurement target and a use case example assumed for the operation target; and
creating, on the basis of a result of the simulation, an operation draft plan indicating an implementation period of maintenance work performed on the operation target.

10. A non-transitory computer readable medium having a computer program stored therein which causes a computer when executed by the computer, to perform processes comprising:
acquiring a deterioration model regarding performance of a similar measurement target which is a measurement target considered to be similar to an operation target, the deterioration model being calculated on the basis of a measurement value of the similar measurement target;
performing a simulation concerning deterioration of performance of the operation target on the basis of the deterioration model regarding the performance of the similar measurement target and a use case example assumed for the operation target; and
creating, on the basis of a result of the simulation, an operation draft plan indicating an implementation period of maintenance work performed on the operation target.

11. An operation-draft-plan creation system comprising:
a measurement target;
a first communication apparatus;
a second communication apparatus; and
a third communication apparatus, wherein
the first communication apparatus sends a measurement value of the measurement target to the second communication apparatus,
the second communication apparatus includes a deterioration-model generator configured to cyclically calculate a probability density distribution of a parameter representing performance of the measurement target calculated at each of a plurality of times on the basis of a measurement value of the measurement target measured before the time and generate a deterioration model regarding the performance of the measurement target on the basis of a calculated plurality of the probability density distributions, and
the third communication apparatus includes:
an acquirer configured to acquire a deterioration model regarding performance of a similar measurement target among the deterioration models regarding the performance of the measurement targets, the similar measurement target being a measurement target considered to be similar to an operation target;
a simulator configured to perform a simulation concerning deterioration of performance of the operation target on the basis of the deterioration model regarding the performance of the similar measurement target and a use case example assumed for the operation target; and
an operation-draft-plan creator configured to create, on the basis of a result of the simulation, an operation draft plan indicating an implementation period of maintenance work performed on the operation target.
